(19) United States
(12) Patent Application Publication
(10) Pub. No.: US 2004/0208428 A1
(43) Pub. Date: Oct. 21, 2004

(54) Wavelength-multiplexed narrow-bandwidth optical transmitter and wavelength-multiplexed vestigial-side-band optical transmitter

(76) Inventors: Nobuhiko Kikuchi, Tokyo (JP); Shigenori Hayase, Kokubunji (JP); Ryoji Takeyari, Koganei (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/083,257

(22) Filed: Feb. 27, 2002

(30) Foreign Application Priority Data
Feb. 20, 2002 (JP) 2002-43099

(51) Int. Cl. G02B 6/293; H04B 10/04

(52) U.S. Cl. 385/24; 398/85

(57) ABSTRACT

Objects of the present invention are to reduce the number of optical filters, and to improve crosstalk characteristics of periodic optical filters. WDM signals are converted into vestigial-side-band signals collectively using a periodic optical filter. As an example, light signals having odd number wavelengths (wavelengths λ1, λ3, λ5) and light signals having even number wavelengths (wavelengths λ2, λ4, λ6) are wavelength-multiplexed in the first optical wavelength multiplexer, and are then filtered by a periodic narrow band-pass optical filter to convert the light signals into vestigial-side-band (VSB) signals. Then, the vestigial-side-band signals are combined by the second optical wavelength multiplexer. Such an interleave configuration enables suppression of crosstalk caused by adjacent channels.

### BACKGROUND OF THE INVENTION

1. Field of the Invention

The present invention relates to an optical wavelength-multiplexed bandwidth narrowing method and an optical vestigial-side-band transmission method (VSB), which are used for reducing bandwidths of light signals in optical information communication using optical fibers, and to configurations of optical transmitters using these methods.

2. Related Art

Wavelength division multiplexing (WDM) optical transmission method is a very effective technique for increasing the capacity of optical fiber communication; in this method, a plurality of optical signals, each of which has a wavelength different from the other, are multiplexed in an optical fiber to transmit information. In recent years, a wavelength division multiplexing optical transmission device, the number of wavelengths of which is more than 100, and total transmission capacity of which is more than 1 Tbit/s, is being commercialized. Experimentally, realization of a transmission system, which has the number of wavelengths and transmission capacity multiplied by further 10 times, is under examination. For the purpose of transmitting such large-capacity information, a very wide frequency (wavelength) band is required. However, an upper limit of its characteristics is limited by an amplification wavelength band of an optical amplifier such as an optical fiber amplifier to which a rare-earth element is added, such as EDFA (Erbium-doped Fiber Amplifier); a semiconductor optical amplifier; or an optical fiber Raman amplifier. The above-described optical amplifiers are used for a wavelength bandwidth where a loss of an optical fiber is low, and are used for relay/amplification of a light signal in the middle of a transmission line. A wavelength band of EDFA of C-band, which is broadly used in general, is 30 nm ranging from 1530 to 1560 nm. Its frequency width is about 3.8 THz. If an L-band optical amplifier or a Raman amplifier is used, the range of the wavelength band and the frequency width can be increased by several times. However, decrease in pumping efficiency causes increase in costs and decrease in performance of the optical amplifier.

As a means for increasing transmission capacity further by utilizing such a limited wavelength band effectively, there is a means for improving frequency (wavelength) density of light signals by reducing signal bandwidths of light signals to multiplexing light signals (optical channels) more densely. The optical wavelength-multiplexed bandwidth narrowing method and the vestigial-side-band transmission method, which are used in the present invention, are examples of such a means.

The optical wavelength-multiplexed bandwidth narrowing method is a technique for reducing a bandwidth of a light signal by passing only a central portion of the light signal, which has been modulated with an information signal, through a narrow band-pass optical filter in order to abandon a high frequency component and a frequency chirp, which exist at both ends of an optical spectrum of the light signal, and which are not required for information transmission.

The vestigial-side-band (VSB) method is a kind of single-side-band (SSB) transmission methods. This is a technique for reducing a transmission band to about a half by passing either one of both side bands of a signal through a filter, or the like, to eliminate the other. Hereinafter, this method will be abbreviated as a VSB method for simplification.

Although both of the techniques are broadly used in radio communication, and the like, there is no example, which has become commercially practical, at present in the field of optical fiber communication. The techniques are in a situation in which they are under basic examination in academic societies, and the like. The following is an example in which the conventional vestigial-side-band method from among both of the techniques is applied to a wavelength division multiplexing optical transmission device. Using this example, disadvantages of the conventional methods relating to both of the techniques will be described.

FIG. 6 illustrates an example of a wavelength division multiplexing optical transmitter to which the conventional VSB method is applied. Signal light sources 106-1 through 106-6 are signal light sources that output light signals having different wavelengths of λ1 through λ6 respectively. Each of the light signals is intensity-modulated with a digital information signal that should be transmitted. In this case, on or off state of the light signal expresses information of 1 or 0 respectively. These signal light sources are usually realized by the following: direct modulation of a semiconductor laser; a combination of a semiconductor laser light source and an optical modulator; or the like. These light signals are inputted into an optical wavelength multiplexer 101 through an input optical fiber 100 and an optical fiber 105, and are then wavelength-multiplexed in the optical wavelength multiplexer 101 before the wavelength-multiplexed signals are output from an output optical fiber 104. The output signals are used for optical fiber transmission as wavelength-multiplexed light. As the optical wavelength multiplexer 101, components such as an AWG (Arrayed Waveguide Grating) and an N input optical coupler, a light signal loss of which is low, are used. In the conventional vestigial-side-band method, output light of the signal light sources 106-1 through 106-6 is filtered by narrow band-pass optical filters 113-1 through 113-6 respectively, each of which has a transmission center wavelength different from the other, in order to convert it into an optical VSB signal on a wavelength basis.

FIG. 7 illustrates this state using optical spectra. For example, a light signal having a center wavelength of λ3, which has been output from the signal light source 106-3, is intensity-modulated with an information signal. Therefore, as shown in FIG. 7(a), at point F where is an input point of the optical filter, a light signal spectrum extends to an area around a center carrier (bold line) of the wavelength λ3 by a width of about a bit rate of the information signal. In this case, a short wavelength side (high frequency side) with respect to the center carrier is called an upper frequency side-band (upper side band); and a long wavelength side is called a lower frequency side-band (lower side band). FIG. 7(b) illustrates transmittivity of the narrow band-pass optical filter 113-3. This filter is an optical band-pass filter having a transmission bandwidth that is about a half of a spectrum width of the light signal. The filter is so devised that a center wavelength of the filter is slightly shifted from a wavelength of the center carrier of the light signal to the long wavelength side or the short wavelength side in order to transmit either of the upper frequency side-band or the lower frequency side-band. In this example, in order to pass only the lower frequency side-band, the upper frequency side-band of the light signal is lost at point G as shown in FIG. 7(c). As a result, the wavelength bandwidth is narrowed by a bandwidth of the lost light signal. As shown in FIG. 7(d), a high-density wavelength-multiplexed signal can be obtained at point H in FIG. 6 by wavelength-multiplexing these light signals using the optical wavelength multiplexer 101.

It is to be noted that even in the case of the optical wavelength-multiplexed bandwidth narrowing method, a configuration of a wavelength division multiplexing optical transmitter is the same. A point of difference from the optical VSB method is that a transmission center wavelength of the narrow band-pass optical filter (for example, 113-3) is adjusted so as to completely agree with a center wavelength (for example, λ3) of a light signal to pass only a center of the light signal. A transmission bandwidth of the optical filter is required to be a width (bit rate) that permits basic frequency components of both side bands to be transmitted, and that permits unnecessary high frequency components to be eliminated. Therefore, the transmission bandwidth becomes wider than that of the VSB method as shown in FIG. 7(e). In addition, a light signal after filtering has both side bands, and its bandwidth is wider than that of the VSB method. Therefore, as shown in FIG. 7(f), density of a signal wavelength decreases a little as compared with the VSB method.

The VSB optical transmitter, which uses the prior art described above, has many disadvantages as shown below. In the first place, because it is necessary to filter each light signal, the number of required optical filters is the same as the number of light signals to be wavelength-multiplexed. This results in increase in costs, and a configuration of a transmitter becomes complicated. In addition, there is another disadvantage that because center wavelengths of these optical filters are different from one another, and also because it is necessary to control bandwidths of the optical filters with a high degree of accuracy (about one-tenth of a signal bit rate), resulting in difficulty in production, and in increase in kinds of spare parts and labor of management.

Moreover, it is necessary to set an interval between a wavelength of a light signal and a center wavelength of a transmission band of a narrow-band filter with a high degree of accuracy (about one-tenth of a signal bit rate: several GHz). Therefore, an error, which occurs between both, produces a great deterioration in characteristics such as transmission distance and crosstalk to adjacent wavelengths. In particular, wavelength stabilization of a light signal at a position, which is shifted from a center of such an optical filter, is influenced by disturbance that is caused by change in intensity of an input light signal, aged deterioration of transmittivity characteristics, or the like. As a result, a control error is easily produced.

In general, a wavelength of an optical filter and a wavelength of a semiconductor laser change by several tens of GHz through few hundred GHz due to change in temperature, change in surrounding environment, and aged deterioration. Conventionally, the following technique is used for wavelength division multiplexing optical transmission: for the purpose of stabilizing a wavelength of a transmission light source, placing a wavelength reference filter such as a wavelength locker inside an optical transmitter; and stabilizing a wavelength of a semiconductor laser as a light source with reference to the wavelength reference filter. However, concerning how to control wavelength relation among the wavelength reference device, a signal wavelength, a narrow band-pass optical filter, which relate to a conventional wavelength-multiplexed narrow-bandwidth optical transmitter and a conventional VSB optical transmitter, no specific solution has been presented in the past. Wavelength deviation, which occurs in the wavelength relation, causes deteriorations in a waveform and transmission characteristics of a light signal, and also causes crosstalk between wavelength-multiplexed signals.

With the conventional configuration, if a wavelength of a transmission light source is made tunable covering a wide range, it is necessary to change transmittivity of the narrow band-pass optical filter to a large extent in response to change in a wavelength of the transmission light source. This produces the following disadvantages: a range within which a wavelength can be tuned is limited; wavelength tunable speed decreases; and the like.

In addition, in the case of the wavelength-multiplexed narrow-bandwidth optical transmitter, there are also substantially the same problems. To be more specific, the number of required optical filters is the same as the number of light signals to be wavelength-multiplexed, which produces the following problems: increase in costs; complication of structure; difficulty in production and management of an optical filter; and the like. Moreover, a wavelength of a light signal is required to agree with a center wavelength of a transmission band of a narrow-band filter with a high degree of accuracy (about one-tenth of a signal bit rate: several GHz). Furthermore, it is difficult to change a wavelength of a transmission light source to a large extent.

### SUMMARY OF THE INVENTION

An object of the present invention is to provide an optical VSB transmitter or a wavelength-multiplexed narrow-bandwidth optical transmitter, which is practical and solves the problems as described above.

In the present invention, the problem that many optical filters are required can be solved by the following processing: wavelength-multiplexing light signals by a first optical wavelength multiplexer; and collectively narrowing bandwidths of the plurality of light signals using an optical filter having periodic transmittivity for a wavelength. In the case of the VSB modulating method, it is also possible to solve the problem in a similar manner by passing only side bands of a plurality of light signals simultaneously using an optical filter having periodic transmittivity in order to collectively convert the side bands into vestigial-side-band signals.

The collective filtering method according to the present invention described above has a problem that crosstalk of a light signal caused by adjacent wavelengths increases. However, it is possible to solve the problem by combining output light of the wavelength division multiplexing optical transmitter, which uses the collective filtering described above, while interleaving the output light every Nth wavelength. To be more specific, output light of N (N is an integer that is greater than or equal to 2) wavelength division multiplexing narrow-bandwidth optical transmitters or N wavelength division multiplexing vestigial-side-band optical transmitters, which output N pairs of wavelength-multiplexed signals for which wavelength interleave has been performed at Nth wavelength intervals respectively, is wavelength multiplexed by a second optical wavelength multiplexer to use the wavelength-multiplexed light as output.

A function of the optical filter having periodic transmittivity according to the present invention may be included in functions of the first or the second optical filters described above. Therefore, the problems described above can be solved by the following processing: using an optical wavelength multiplexer, transmittivity of which has wavelength dependency, for the first wavelength multiplexer or the second optical wavelength multiplexer, or for both of them; for each light signal having a different wavelength of the optical wavelength multiplexer, making a transmission bandwidth narrower than a spectrum width of a light signal; and adjusting a plurality of transmission peak wavelengths of the optical wavelength multiplexer so as to become substantially equivalent to center wavelengths of light signals incident on the second optical wavelength multiplexer respectively, or adjusting the plurality of transmission peak wavelengths so as to become substantially equivalent to single side band portions of the light signals respectively.

In case of the present invention, that a wavelength is adjusted so as to become substantially equivalent to center wavelength of light is, for example, to making a frequency difference between two wavelengths into with accuracy of less than one-fourth of signal bit-rate. It is preferable for decreasing spectrum width of a signal into about one-second of signal bit-rate to make accuracy of a center frequency of a filter into with half of at least about one-second of signal bit-rate in case of a wavelength-multiplexed narrow-bandwidth optical transmit method and in case of a vestigial-signal-band optical transmit method.

In addition, as regards the problem of the optical vestigial-side-band method that the wavelength offset quantity between a center wavelength of a light signal and a center wavelength of an optical filter must be controlled with a high degree of accuracy, the following means are adopted. To be more specific, a light signal is divided into a plurality of optical paths, and is transmitted through one or more optical filters, each of which has a transmission bandwidth narrower than a spectrum width of a signal; and peak wavelengths of transmittivity of the optical filters are set so that each of the peak wavelengths slightly differs from the other for each optical path. Additionally, a light signal, which has passed one optical path from among them, is used to transmit an information signal as an optical vestigial-side-band signal; and a wavelength of the light signal or a transmission wavelength of the optical filter is controlled so that intensity of the light signals, which have been transmitted through the optical paths, becomes equal or shows a constant ratio. In this case, two optical filters, each of which has characteristics different from the other, may be used; or one optical filter may be shared in two optical paths.

A difference between peak wavelengths of two optical filters is determined by necessary condition that a optical signal transmitted through a filter in one side becomes a single side band signal. It is preferable that the difference is set in range of at least from one-second of a signal bit-rate of an optical signal to two times the signal bit-rate.

This wavelength stabilization technique can also be applied to a case where wavelength-multiplexed signals are converted into VSB signals collectively using optical filters having periodic transmittivity. In this case, transmission signal intensity of two filters is detected in order to stabilize wavelengths. More specifically, two filters means a first optical filter having periodic transmittivity; and a second optical filter that has a peak of transmittivity at a point where there is slight wavelength deviation from a peak of transmittivity characteristics of the first optical filter, and that has periodic transmittivity. It is to be noted that the first and the second optical filter may be the same as long as transmittivity for two light signals are different.

In addition, concerning wavelength relation between a light signal and a device for stabilizing narrow-band filter wavelength according to the present invention, an optical filter having periodic transmittivity for wavelength is used for both of the narrow band-pass optical filter and the device for stabilizing wavelength; and wavelength periods of transmittivity for both are set at an integral multiple or a submultiple each other. Thus, a VSB light signal and a narrow-bandwidth light signal can be obtained at constant wavelength intervals decided by the ITU standards. This permits the present invention to be broadly applied. Using this configuration in order to make wavelengths of an optical transmitter tunable provides solutions to the following disadvantages that have been the problems so far: a narrow band-pass optical filter is required to follow a wavelength; a range within which a wavelength can be tuned decreases; wavelength tunable speed becomes low; and the like.

Moreover, it is preferable that this optical filter and the wavelength reference device are placed on the same case or substrate so that both are thermally coupled each other. This prevents wavelength deviation in transmittivity of both. As a result, it is possible to solve the following problems, which are caused by wavelength deviation of both: a waveform and transmission characteristics of a light signal deteriorate; and crosstalk occurs between wavelength-multiplexed signals. This problem can be solved by controlling a transmission wavelength of the optical filter with reference to the wavelength reference device so that wavelength deviation in transmittivity of both from a predetermined position is not caused. In a similar manner, it is also possible to solve this problem by the following processing: controlling a wavelength of a light signal so that a center wavelength of the light signal deviates from a peak of transmittivity of the optical filter by the predetermined quantity; passing only a single side band of a light signal by an optical filter; and controlling a transmission wavelength of the optical filter so that a center wavelength of the light signal having only a single side band agrees with the reference wavelength of the wavelength reference device. This technique can be combined with the technique for stabilizing the wavelength deviation quantity between a light signal wavelength and a filter transmission wavelength, which uses two narrow band-pass optical filters according to the present invention, each of which has a transmission peak deviated from the other. This enables us to solve the problems in a similar manner.

### BRIEF DESCRIPTION OF THE DRAWINGS

FIG. 1 is a diagram illustrating a first embodiment according to the present invention;

FIGS. 2(a) through 2(c) are diagrams illustrating spectra of light signals and transmittivity of an optical filter shown in FIG. 1;

FIGS. 3(a) through 3(e) are explanatory diagrams illustrating occurrence of crosstalk in the first embodiment of the present invention;

FIG. 4 is a diagram illustrating a second embodiment according to the present invention;

FIGS. 5(a) through 5(e) are diagrams illustrating spectra of light signals and transmittivity of an optical filter shown in FIG. 4;

FIG. 6 is a diagram illustrating a configuration of a conventional optical VSB transmitter or a conventional narrow-bandwidth optical transmitter;

FIGS. 7(a) through 7(f) are diagrams illustrating spectra of light signals and transmittivity of an optical filter shown in FIG. 6;

FIG. 8 is a configuration example of an interleaver according to the present invention;

FIGS. 9(a) through 9(c) are diagrams that explains on optical spectra operation of an interleaver according to the present invention;

FIG. 10 is a diagram illustrating a third embodiment according to the present invention;

FIGS. 11(a) through 11(d) are diagrams illustrating spectra of light signals and transmittivity of an optical filter shown in FIG. 10;

FIG. 12 is a diagram illustrating a fourth embodiment according to the present invention;

FIGS. 13(a) through 13(d) are diagrams illustrating spectra of light signals and transmittivity of an optical filter shown in FIG. 12;

FIG. 14 is a diagram illustrating a fifth embodiment according to the present invention;

FIGS. 15(a) through 15(d) are diagrams illustrating positions of wavelengths of light signals relating to a narrow band-pass optical filter in FIG. 14;

FIGS. 16(a) through 16(e) are diagrams illustrating principles of light signal wavelength control in FIG. 14;

FIG. 17 is a diagram illustrating a sixth embodiment according to the present invention;

FIGS. 18(a) and 18(b) are diagrams illustrating positions of wavelengths of light signals relating to a narrow band-pass optical filter in FIG. 17;

FIG. 19 is a diagram illustrating a seventh embodiment according to the present invention;

FIG. 20 is a typical perspective view illustrating an eighth embodiment according to the present invention; and

FIG. 21 is a diagram illustrating a ninth embodiment according to the present invention.

### DETAILED DESCRIPTION OF THE PREFERRED EMBODIMENTD

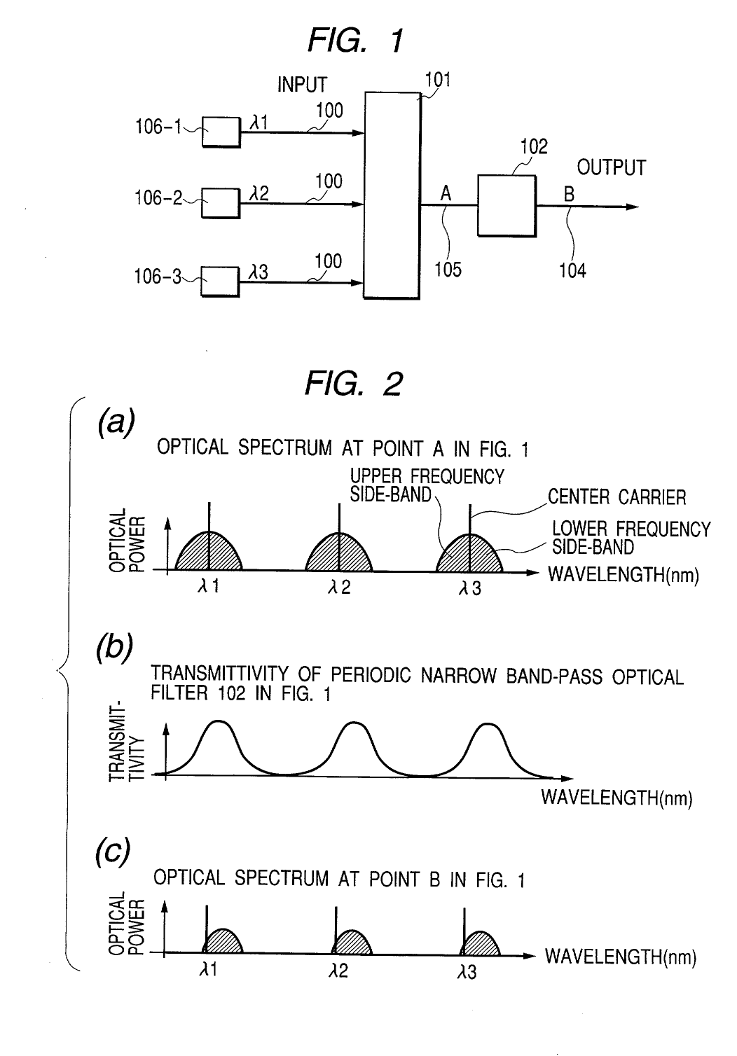

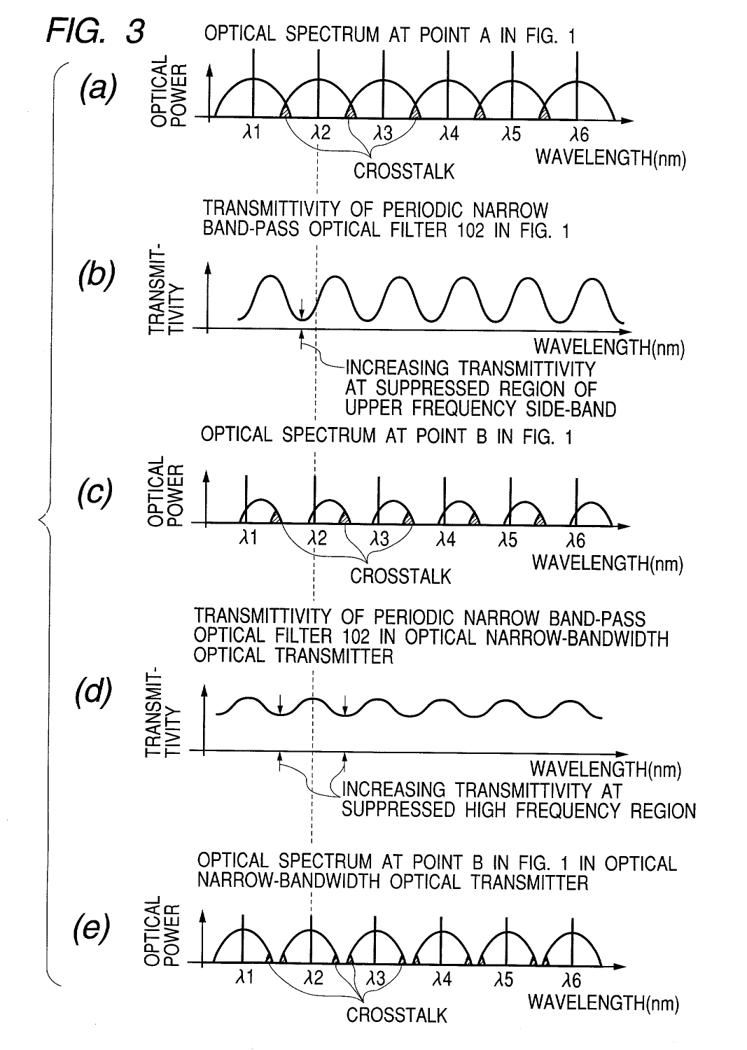

FIG. 1 is a configuration diagram illustrating a first embodiment of the present invention. It shows a configuration of a wavelength-multiplexed vestigial-side-band (VSB) optical transmitter according to the present invention. Its essential parts will be described as follows. To be more specific, output light of three signal light sources 106-1, 106-2, 106-3 having different wavelengths one another (wavelengths λ1, λ2, λ3) is led to a first optical wavelength multiplexer 101 through input optical fibers 100, and is then wavelength-multiplexed. After that, a periodic narrow band-pass optical filter 102, which has periodic transmittivity relating to an input wavelength, filters the wavelength-multiplexed light collectively, and converts the filtered light into an optical VSB signal, which is output from an output fiber 104.

FIG. 2 illustrates principles of the present invention using optical spectra. FIG. 2(a) illustrates a spectrum of a light signal at an output point (point A) of the first optical wavelength multiplexer 101-1 shown in FIG. 1. Through one optical fiber, three light signals, which have wavelengths of λ1, λ2, λ3 respectively, are transmitted with wavelength multiplexing. Because each light signal is intensity-modulated with an information signal, the optical spectrum extends to an area around a center carrier, which causes two side bands (upper frequency side-band and lower frequency side-band) to appear on both sides. FIG. 2(b) illustrates transmittivity of the periodic narrow band-pass optical filter 102. Within a range of this figure, peaks of three transmittivity appear periodically. Its period is the same as a wavelength interval of a wavelength-multiplexed signal. Peak positions of these transmission wavelengths are provided so that they substantially agree with centers of lower frequency side-bands of the plurality of light signals, which are transmitted with wavelength multiplexing, respectively. In this example, only three periods of transmittivity of the optical filter are shown. However, in actuality, it is possible to use an optical filter, the number of peaks of transmission characteristics of which is several tens to hundreds or more, in correspondence with the number of wavelengths of a light signal. FIG. 2(c) illustrates a spectrum of a light signal at an output point B of the periodic narrow band-pass optical filter 102. Only a portion in and around each lower frequency side-band of the signals, which have wavelengths of λ1, λ2, λ3 respectively, is passed before each signal is converted into an optical VSB signal. As a result, a wavelength band of each signal is reduced to about a half of that in FIG. 2(a).

It is to be noted that although this example shows a case where a lower frequency side-band is passed, passing an upper frequency side-band also exerts no influence on configurations and effects of the present invention. In addition, this example shows a case where the wavelength-multiplexed VSB transmitter is used. However, even if a wavelength-multiplexed narrow-bandwidth optical transmitter is used, configurations are the same. A point of difference with the optical VSB method is that a transmission center wavelength of the narrow band-pass optical filter (for example, 113-3) is adjusted so as to agree with a center wavelength (center carrier) of both side band light signals completely to pass a center of the light signal.

Moreover, in this example, a peak interval of transmittivity of the narrow band-pass optical filter is the same as a wavelength interval of a wavelength-multiplexed signal. However, it may be a submultiple. This has an advantage that it is possible to shorten a wavelength period (Free Spectral Range (FSR)) of the optical filter as compared with a wavelength interval of a light signal. There is an upper limit of Q value (=FSR/transmission bandwidth) for usual optical filters. Therefore, it is difficult to realize a filter having a narrow transmission bandwidth if FSR is fixed. However, if FSR can be narrowed, even if Q value of an optical filter is the same, it becomes possible to realize an optical filter having a narrow transmission bandwidth used for an optical VSB method easily.

Additionally, in this example, although light signals are provided at all peak positions of the transmittivity, it is not always necessary to do so. Even if there is an unused wavelength, for the purpose of avoiding degradation by four-wave mixing (FWM) at the time of optical fiber transmission, it is also possible to provide a light signal only at a specific transmission peak so that a wavelength interval of the light signal becomes an unequal interval.

Moreover, as a light signal used in this example, any kind of modulating method can be applied as long as it is a modulating method in which a light signal has both side bands, or as long as it is a modulating method in which narrowing of band is possible. As the former method, for example, various modulation codes such as NRZ (Non-Return to Zero), RZ (Return-to-Zero), and CSRZ (Carrier-Suppressed RZ) can be applied. As the latter method, in addition to the examples of the former method, optical duo-binary modulation can also be applied. If the above conditions are satisfied, a method other than the intensity modulation may also be applied.

In addition, this example has a configuration in which optical parts are coupled, or perform light input/output, using the input optical fibers 100, the optical fiber 105, and an output optical fiber 104. However, the present invention is not always limited to this configuration. For example, each component can also be coupled using a collimated beam propagating in a space; or each component can also be coupled using a waveguide. In addition, if each component is aligned so as to be adjacent to one another, it is not always required.

As the first optical wavelength multiplexer 101, any device can be used as long as it is a device having a function of combining light signals having different wavelengths one another, which are inputted from a plurality of paths, into one to output the combined signal as one light signal. For example, an optical directional coupler, a star coupler, and a beam splitter, which have no wavelength dependency, can be used. Additionally, the following units can also be used: AWG that is a low-loss optical wavelength multiplexer having wavelength dependency; an optical wavelength multiplexer in which a dielectric multilayer film filter and an optical fiber grating are connected in a multistage manner; and the like.

As the periodic narrow band-pass optical filter 102, any filter can be used basically as long as it is a narrow band-pass optical filter having periodic transmittivity such as a Fabry-Perot optical resonator, and Mach-Zehnder optical interferometer, and an optical ring resonator.

However, in the first embodiment described above, there may be a case where when wavelength intervals are provided closely, crosstalk occurs between light signals, causing degradation of transmission characteristics. FIG. 3 is a diagram illustrating principles how crosstalk occurs, using optical spectra. If the number of wavelengths is increased to make intervals of light signals close in the first configuration, bottom edges of an optical spectrum of a wavelength-multiplexed signal at point A in FIG. 1 begin to be overlapped with bottom edges of adjacent signals as shown in FIG. 3(a). This is a leak (crosstalk) to adjacent wavelengths of a light signal, which greatly degrades transmission characteristics such as receive sensitivity and transmission distance greatly. If there is crosstalk at the time of first optical multiplexing, even if a lower frequency side-band of each light signal is passed by the periodic narrow band-pass optical filter 102 having transmittivity as shown in FIG. 3(b), a VSB signal, which appears at output point B, is output with included crosstalk, causing degradation of the light signal. Such a phenomenon occurs when a wavelength interval of a light signal becomes close to a spectrum width of the light signal (approximately a value obtained by multiplying a bit rate by 1 to 2). For example, in the case of a light signal that is intensity-modulated at 40 Gbit/s, a spectrum width of the light signal extends to about 40 through 60 GHz. Therefore, this is a case where a wavelength interval is about 0.8 nm or less (100 GHz or less). In addition, characteristics of the periodic narrow band-pass optical filter also begin to be degraded as a wavelength interval becomes closer. A bandwidth of the narrow band-pass optical filter is required to be about a width of a side band. If the bandwidth is narrowed by force, degradation in a waveform will occur. Because of it, if a wavelength interval becomes close, suppression characteristics of the optical filter degrades. As shown with an arrow in FIG. 3(b), for example, transmittivity becomes high in a part where an upper frequency side-band of a signal having a wavelength of λ2 should be suppressed. In each light signal having a different wavelength after filtering, crosstalk from an adjacent signal occurs as shown in FIG. 3(c), resulting in great degradation of transmission characteristics. This is a new problem produced when a light signal having a plurality of wavelengths is converted into a VSB signal collectively by one narrow band-pass optical filter. Concerning the first embodiment, it is necessary to design the transmitter while taking this point into consideration.

In this connection, such crosstalk also occurs in the case of the wavelength-multiplexed narrow-bandwidth optical transmitter. To be more specific, when wavelengths are multiplexed with narrowed wavelength intervals of light signals, crosstalk occurs among light signals from the beginning in the same way. Moreover, transmittivity of the periodic optical filter are also degraded as shown with arrows in FIG. 3(d), which decreases the effect of narrowing of band. Because of it, adjacent signals cause crosstalk in a light signal after filtering as shown in FIG. 3(e), resulting in great degradation of transmission characteristics. Also in the case of the wavelength-multiplexed narrow-bandwidth optical transmitter, it is necessary to design the transmitter according to the first embodiment while taking this point into consideration.

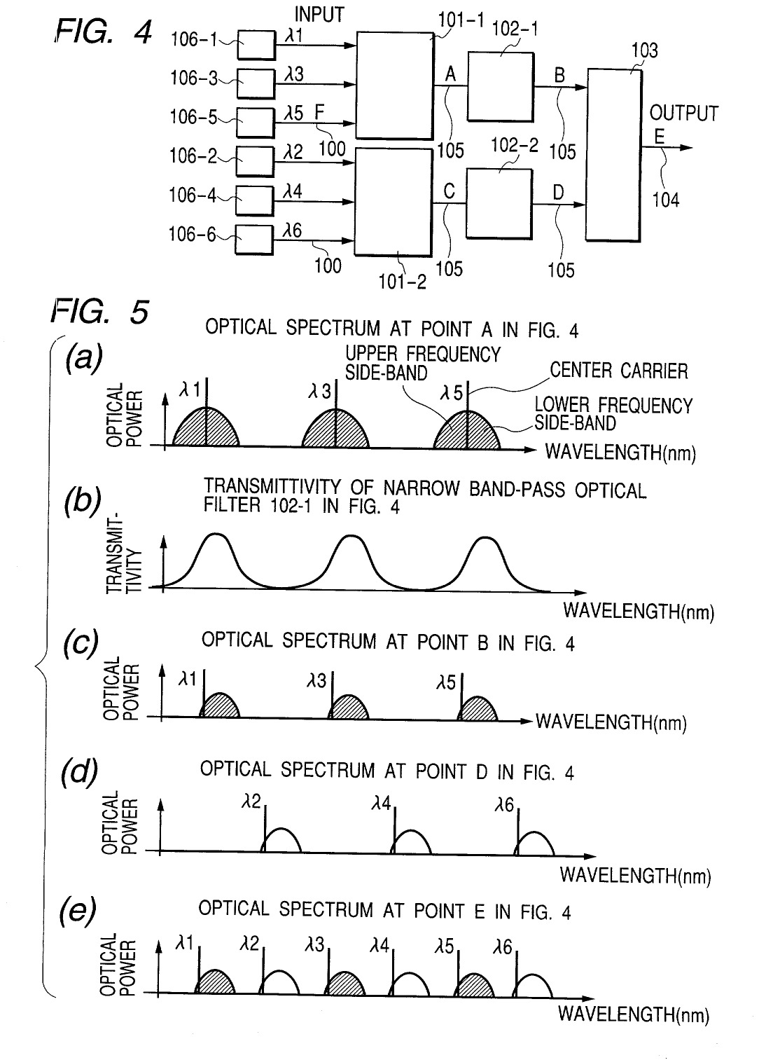

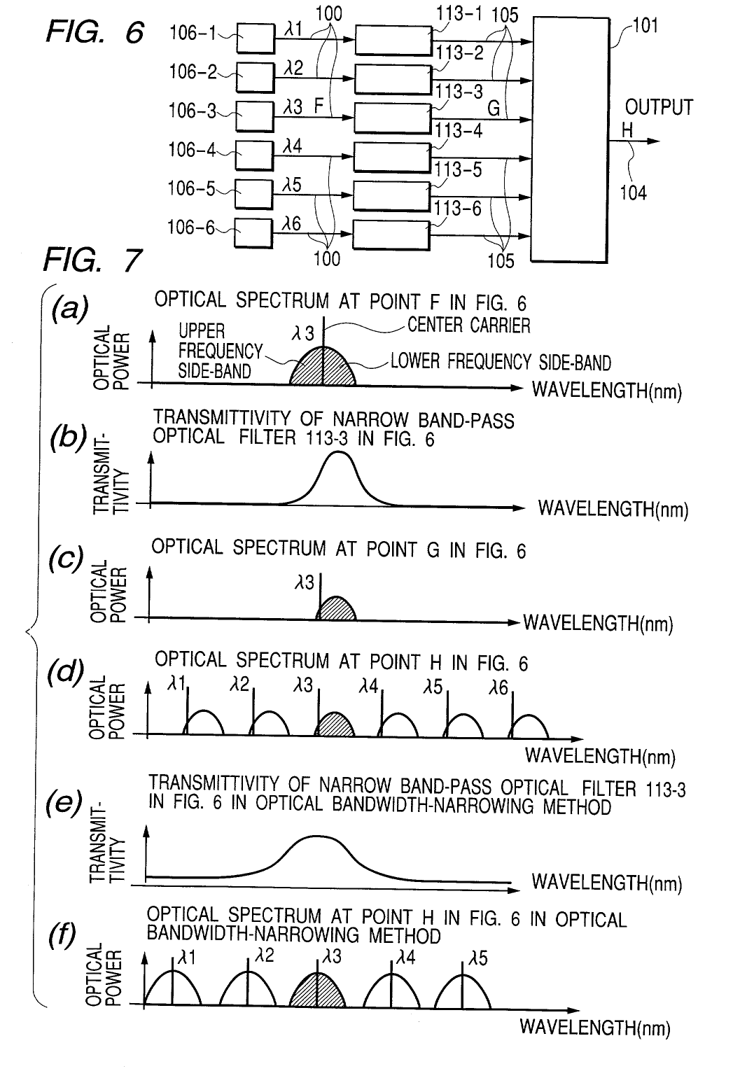

FIG. 4 is a configuration diagram illustrating a second embodiment of the present invention. This example solves disadvantages found in the first embodiment of the present invention described above. This embodiment has a configuration in which crosstalk at the time of improvement in wavelength density is reduced by further wavelength-multiplexing the wavelength-multiplexed signal in FIG. 1 with another wavelength-multiplexed signal using a wavelength multiplexer such as an interleaver or and an optical coupler. Signal light sources 106-1, 106-3, 106-5 (wavelengths λ1, λ3, λ5), which are odd number wavelengths if they are counted from the short wavelength side, are led to a first optical multiplexer 101-1 through input optical fibers 100, and are wavelength-multiplexed. In addition, signal light sources 106-2, 106-4, 106-6, which have even number wavelengths (wavelengths λ2, λ4, λ6), are also wavelength-multiplexed in the second optical wavelength multiplexer 101-2 in the same manner. Each of the light signals is converted into a VSB light signal individually by each of periodic narrow band-pass optical filters 102-1, 102-2 having periodic transmittivity.

FIG. 5 illustrates this state using optical spectra. Using the same steps as those in the first embodiment, wavelength light signals having odd number wavelengths of λ1, λ3, λ5, which are shown in FIG. 5(a), are converted into wavelength-multiplexed VSB light signals shown in FIG. 5(c) by an optical filter 102-1 before the converted signals are output to point B in FIG. 4. In this connection, transmittivity of the optical filter 102-1 are exemplified in FIG. 5(b).

On the other hand, light signals having even number wavelengths are also converted into wavelength-multiplexed VSB light signals shown in FIG. 5(d) by an optical filter 102-2 before the converted signals are output to point D in FIG. 4. Two sets of the light signals are wavelength-multiplexed by a second optical wavelength multiplexer 103 according to the present invention, and are then converted into high-density wavelength-multiplexed signals in FIG. 5(e), which are output from an output fiber 104.

In this manner, if optical filtering is performed by the periodic narrow band-pass optical filter while wavelengths are divided into odd number wavelengths and even number wavelengths, it is possible to make intervals of signal wavelengths before filtering wider as compared with those in the first embodiment, which enables suppression of crosstalk caused by adjacent wavelengths. In addition, because a wavelength period of a periodic optical filter can also be made longer, it is also possible to improve crosstalk suppression characteristics of the optical filter.

By the way, also in the case of an optical wavelength-multiplexed bandwidth narrowing method, a configuration is the same as FIG. 4. However, a transmission center wavelength of an optical filter should be equivalent to a center wavelength of each light signal; in addition, a bandwidth of the optical filter should be suitable for this method.

Moreover, as the second optical wavelength multiplexer 103 according to the present invention, any device can be used as long as it is a device that combines light signals, each of which has a wavelength different from the other, and which are inputted from a plurality of paths, into one to output the combined signal as one light signal. For example, as is the case with the first wavelength multiplexer, the following devices can be used: an optical directional coupler (optical coupler); a star coupler; a beam splitter; AWG; an optical wavelength multiplexer in which a dielectric multilayer film filter and an optical fiber grating are connected in a multistage manner; and the like.

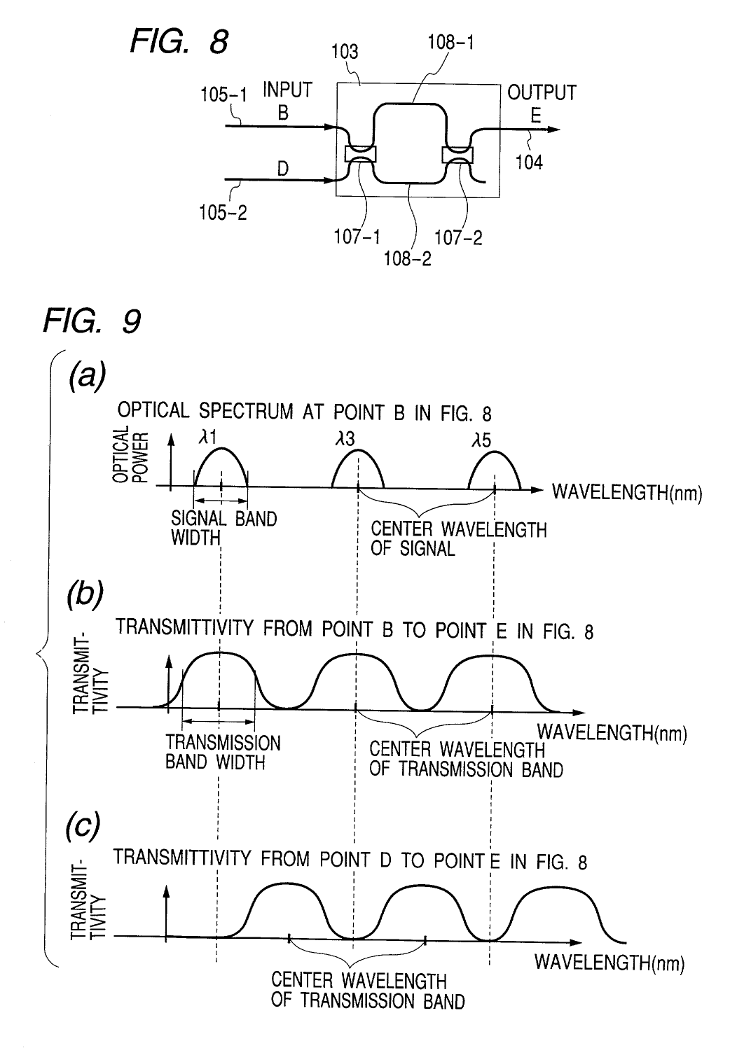

FIG. 8 illustrates a configuration example in which an interleaver is used as the second optical wavelength multiplexer 103 according to the present invention. The interleaver is a component that combines odd number wavelengths and even number wavelengths, or separates wavelengths into odd number wavelengths and even number wavelengths, with low loss in high-density wavelength division multiplexing transmission. For example, as shown in FIG. 8, the interleaver can be configured by Mach-Zehnder interferometer on a waveguide such as a glass substrate. This figure illustrates an example of a wavelength multiplexer where two optical fibers 105-1, 105-2 as inputs are coupled to an optical coupler 107-1. Two outputs of the optical coupler are connected to optical waveguides 108-1, 108-2, each of which has a length different from the other, and are then coupled in an optical coupler 107-2 again. In addition, one of the two outputs is connected to an output optical fiber 104.

FIG. 9 is a diagram for explaining operation of this interleaver on optical spectra. If difference in delay time between two waveguides 108-1, 108-2 is T, its transmittivity has a period of frequency 1/T on an optical spectrum. If this period is set so that the period becomes equivalent to an interval between even number wavelengths (or odd number wavelengths), transmittivity from input point B to output point E in FIG. 8, for example, will become those shown in FIG. 9(b). In addition, transmittivity from input point D to output point E in FIG. 8 will become those shown in FIG. 9(c). In this manner, both show alternate transmittivity on optical spectra. Therefore, for example, if light signals having odd number wavelengths are inputted in the optical fiber 105-1, and as shown in FIG. 9(a), if their center wavelengths are adjusted so as to agree with centers of transmission bands in FIG. 9(b), these light signals are led to an output optical fiber 105 with low loss. In a similar manner, if light signals having even number wavelengths are inputted in the optical fiber 105-2, and if their center wavelengths are adjusted so as to agree with centers of transmission bands in FIG. 9(c), these light signals are also led to the output optical fiber 105. They are principles of operation of the interleaver. Actual interleavers may be devised as follows: a transmission bandwidth is magnified by further connecting several stages of interferometers; or transmittivity in a band is improved so that they become flatter. Moreover, the interleaver is not limited to waveguide structure. The interleaver may be realized by a bulk optical system in which optical crystals are combined. However, even if any kind of structure is used, the interleaver can be applied to the present invention without problems.

By the way, as the second optical wavelength multiplexer 103 in this method, a configuration using a polarization wavelength multiplexer, which utilizes polarization, is based on a theoretically different method. Therefore, such configuration cannot be applied. To be more specific, the polarization wavelength multiplexer is an optical device that combines two light inputs of a polarization beam splitter, a polarization maintaining coupler, etc., at the points B and C with polarization to output the combined signal to point E. To be more specific, the polarization wavelength multiplexer means a configuration of polarization interleave multiplexing, which transmits odd number wavelengths and even number wavelengths separately by cross polarization. The reason is that polarization combining is “a general technique for reducing crosstalk by crossing light signal polarization of adjacent wavelengths”, and that the polarization combining is different from a technique for reducing crosstalk by extending a signal wavelength interval and FSR of a periodic narrow band-pass optical filter by wavelength interleave when performing collective optical filtering according to the present invention. It is to be noted that if polarization is wavelength-multiplexed, it is necessary to maintain polarization totally for a path of a light signal from a light source 106 to the second optical wavelength multiplexer 103. This produces problems of increasing cost, increasing complexity of a transmitter, and the like.

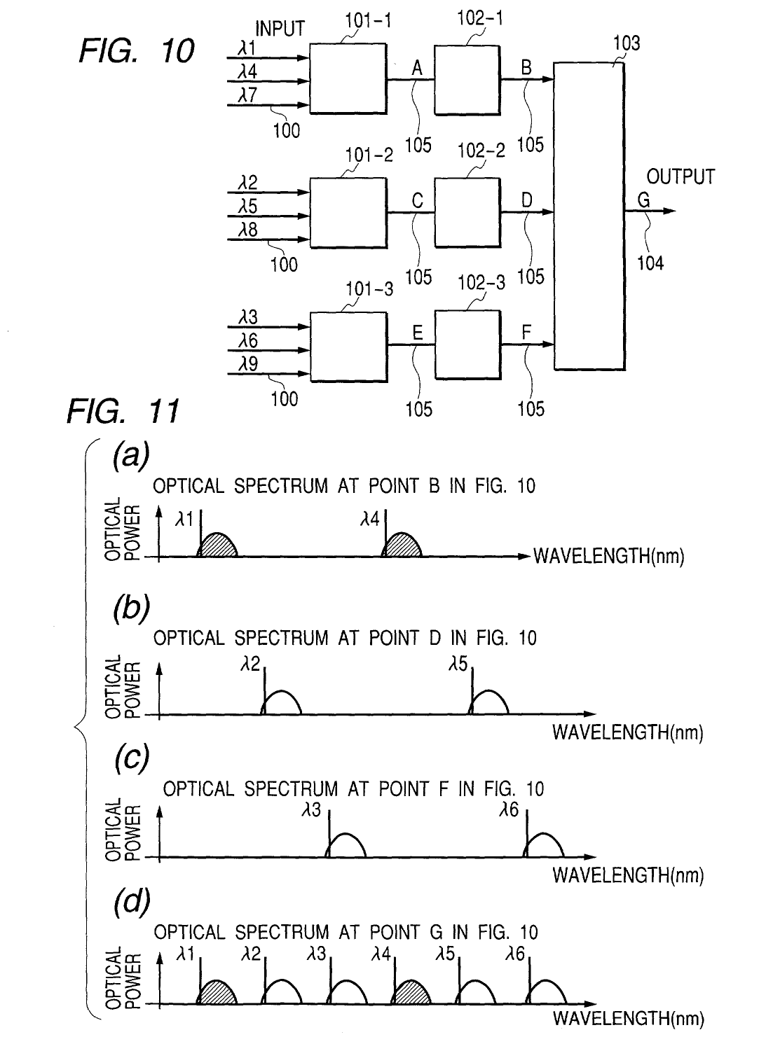

FIG. 10 illustrates a third embodiment of the present invention. To be more specific, FIG. 10 illustrates a configuration in which light signals are wavelength-multiplexed while the light signals are interleaved every three wavelengths in increasing order of wavelength. In other words, light signals are divided into three sets, that is to say, wavelengths 3N+1, 3N+2, and 3N (N is an integer); each of the sets is wavelength-multiplexed by the first optical wavelength multiplexers 101-1, 101-2, 101-3 according to the present invention respectively to convert it into a wavelength-multiplexed signal; and each of the wavelength-multiplexed signals is converted into a VSB signal by periodic narrow band-pass optical filters 102-1, 102-2, 102-3 respectively. Each spectrum of the light signals is shown in FIGS. 11(a), 11(b), 11(c) respectively. It is to be noted that the figures show only a part (six wavelengths) of optical spectra. After that, these light signals are wavelength-multiplexed by the second optical wavelength multiplexer 103 according to the present invention, and are then converted into high-density wavelength-multiplexed signals as shown in FIG. 11(d). In this manner, by increasing a cardinal number of interleave (in this example, 3) to a desired value, it is possible to widen intervals of light signals, which are inputted into the periodic optical filters 102, and it is also possible to make characteristics of this filter steeper. Therefore, further suppression of crosstalk caused by adjacent wavelengths becomes possible. As a matter of course, even in this example, an optical coupler or an interleaver may be used as the second wavelength multiplexer. In addition, it can be applied not only in the VSB method but also in the optical bandwidth narrowing method.

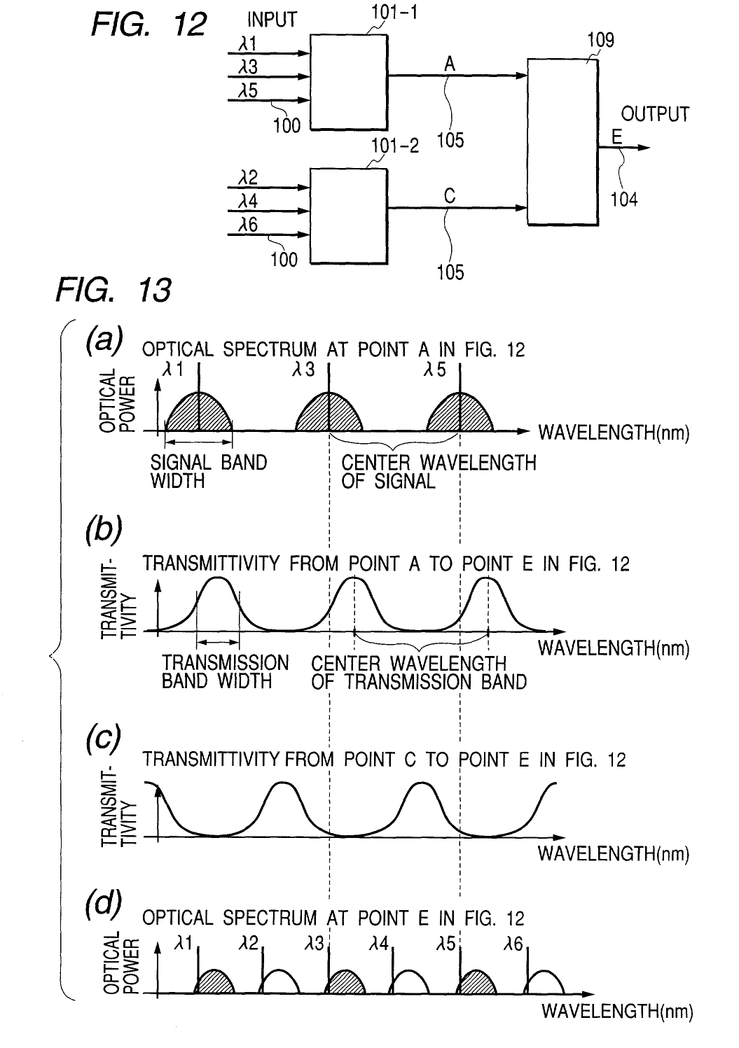

FIG. 12 illustrates a fourth embodiment of the present invention. This is an example in which a function of a periodic optical filter is built into the second optical wavelength multiplexer. FIG. 13 is a diagram illustrating positions of wavelength-multiplexed signals, and transmittivity of the optical wavelength multiplexer, in this embodiment using optical spectra. In this example, wavelength-multiplexed light signals having odd number wavelengths and even number wavelengths, which have been wavelength-multiplexed by the first wavelength multiplexers 101-1, 101-2, are inputted into an interleaver with narrow band-pass optical filter 109. The light signals having both odd number wavelengths and even number wavelengths are wavelength-multiplexed concurrently with narrow-band filtering, and are then output from the output optical fiber 104. Both of the narrow band-pass optical filter and the interleaver are optical devices that have periodic transmittivity. Therefore, as shown in this example, they can be configured to be combined with the same substrate or module. This enables reduction in costs and the number of parts that require accuracy of wavelength. As shown in FIG. 9(b), generally used interleavers have a transmission bandwidth wider than a signal band. However, as shown in FIG. 13(b), the interleaver with narrow band-pass optical filter in this example has a transmission bandwidth that is substantially the same as a signal bandwidth or narrower than the signal bandwidth. As a result of it, a bandwidth of a light signal corresponding to each wavelength is narrowed as shown in FIGS. 13(a) through 13(d). Therefore, difference between them can be found easily. In particular, in the VSB method, a center wavelength of a transmission band of an optical filter is offset to a center of single side band of a signal wavelength as shown in FIGS. 13(a), 13(b). In addition, as shown in FIG. 13(d), a light signal, which is obtained after the light signal is transmitted through the optical filter, is converted into a VSB light signal. Therefore, judging from the above, both of them can be distinguished more easily.

By the way, this example shows a configuration in which the narrow band-pass optical filter is built into the second wavelength multiplexer. However, it is also possible to build the narrow band-pass optical filter into the first wavelength multiplexer in a similar manner; or it is also possible to combine three components, that is to say, the narrow band-pass optical filter, the first wavelength multiplexer, and the second wavelength multiplexer into one in order to configure them as one optical part. Even in this case, as is the case with the above, judging from a transmission bandwidth, a position of a center wavelength of transmission, and change in a spectrum shape of a light signal before and after transmission, which relate to each wavelength multiplexer, it is possible to know that the present invention has been applied.

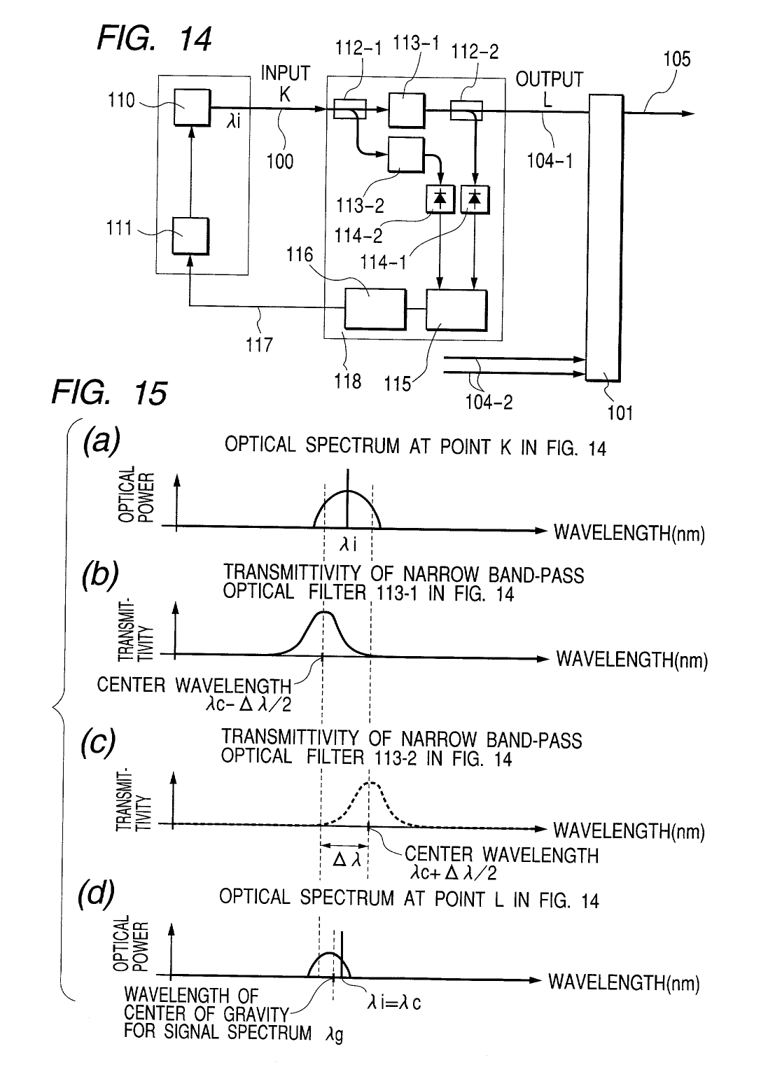

FIG. 14 illustrates a fifth embodiment of the present invention. This is an example that shows a technique for stabilizing a light signal and a wavelength of the narrow band-pass optical filter mutually in an optical VSB method in particular. This embodiment is characterized by the following: two narrow band-pass optical filters 113-1, 113-2, in which peak wavelengths of transmittivity are mutually and slightly deviated, are used as the reference of a light signal wavelength; and one of them is used also as a narrow band-pass optical filter that converts a light signal into a VSB signal. A semiconductor light source 110, which outputs a light signal having one wavelength modulated with an information signal, is connected to a temperature control circuit 111, which enables adjustment of a light signal wavelength. An output light having a wavelength of λi is inputted into a narrow band-pass optical filter with wavelength deviation detecting function 118 through an input optical fiber 100. Inside the narrow band-pass optical filter with wavelength deviation detecting function 118, the light signal is divided into two by an optical demultiplexer 112-1. After that, one of the divided light signals is inputted into a narrow band-pass optical filter 113-1, and the other is inputted into a narrow band-pass optical filter 113-2. The light signal, which has passed through the narrow band-pass optical filter 113-1, is converted into an optical VSB signal. The optical VSB signal is divided into two by an optical demultiplexer 112-2, and then one of them is output to outside through an output optical fiber 104-1. This signal is wavelength-multiplexed with other optical VSB signals, which are transmitted from a plurality of output optical fibers 104-2, by a wavelength multiplexer 101 to produce a wavelength-multiplexed signal.

On the other hand, intensity of output signals of the two narrow band-pass optical filters 113-1, 113-2 is converted into electric signals by photodetectors 114-1, 114-2 respectively. The electric signals are used for stabilization control that always keeps a wavelength interval (wavelength offset) between a center wavelength of an input light signal and a center wavelength of a VSB optical filter constant.

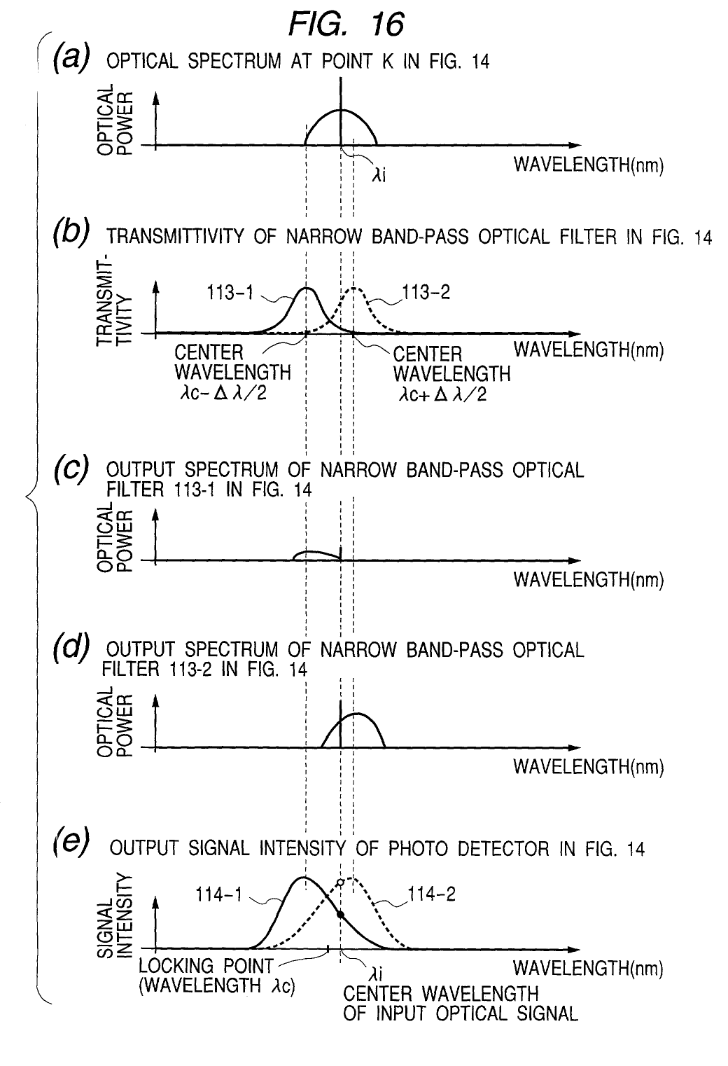

FIG. 15 is a diagram illustrating positions of wavelengths of light signals relating to the narrow band-pass optical filter. As shown in FIG. 15(a), a light signal at point K in FIG. 14, where is an input point of the narrow band-pass optical filter with wavelength deviation detecting function 118, is a light signal that has both frequency side bands at a center wavelength of λi. Two narrow band-pass optical filters 113-1 and 113-2 are optical filters, each of which has the same transmission shape and transmission bandwidth as those of the other. Center wavelengths of the narrow band-pass optical filters 113-1 and 113-2 are set at positions where an upper frequency side-band and a lower frequency side-band of a light signal can be passed respectively. More specifically, a wavelength interval Δλ between both center wavelengths of transmission is set so that the wavelength interval Δλ becomes twice as long as an optimum wavelength offset at the time of generation of the VSB signal described above. To be more specific, transmission center wavelengths of both narrow band-pass optical filters becomes λc−Δλ/2, λc+Δλ/2 respectively. If settings are performed in this way, as shown in FIG. 15(a), when a central frequency λi of a light signal agrees with λc that is just a center of transmittivity of the two optical filters shown in FIG. 15(b) and FIG. 15(c), a light signal output from the optical filter 113-1 is converted into an optimum VSB signal as shown in FIG. 15(d). In this connection, because a light signal is output after it is converted into a VSB signal, its center wavelength Ag slightly deviates from λc.

Wavelength control of a light signal or an optical filter is realized by a subtraction circuit 115 and a zero-point control circuit 116. FIGS. 16(a) through 16(e) show its principles. FIG. 16(a) illustrates an optical spectrum at point K that is an input point. FIG. 16(a) shows a case where a wavelength λi of a light signal deviates from a predetermined locking point (λc: the middle of transmission center wavelengths of both filters) to a long wavelength side. In this case, intensity of a light signal, which is transmitted through the narrow band-pass optical filter 113-1, decreases as shown in FIG. 14C; and intensity of a light signal, which is transmitted through the narrow band-pass optical filter 113-2, increases as shown in FIG. 14A. FIG. 14E illustrates intensity of electric signals obtained from the photodetector 114-1 and the photodetector 114-2 when a position of a signal wavelength λi changes. As shown in the example described above, when the signal wavelength λi deviates from locking point λc to the long wavelength side, it is found out that an output signal (white circle) of the photodetector 114-2 becomes larger than an output signal (black circle) of the photodetector 114-1. In addition, if the signal wavelength λi agrees with the locking point λc, intensity of both becomes equal. Therefore, the center wavelength λi of the light signal can be always kept at a value equivalent to λc by the following processing: determining difference in intensity of both photodetectors 114-1, 114-2 using the subtraction circuit 115; generating a control signal 117 in a direction, in which an output of the subtraction circuit 115 becomes zero (in this example, shifting in a short wavelength direction), using the zero-point control circuit 116; and using the temperature control circuit 111 to perform feedback control so that a wavelength of a light signal changes.

Such wavelength stabilization permits a wavelength offset of a signal wavelength for the narrow band-pass optical filter to be kept at a predetermined value with a high degree of accuracy. Using two optical filters to stabilize wavelengths with reference to difference in wavelength between the optical filters, as shown in this embodiment, provides an advantage that even if transmittivity of an optical filter and input signal intensity change due to aged deterioration, or the like, its influence can be excluded. Moreover, signal intensity passing through an optical filter, which has a transmission peak on a side where a light signal deviates, always becomes high. Because of it, if intensity of signals, which are obtained from two photodetectors, is compared, it is possible to judge which direction the light signal has deviated, that is to say, the long wavelength side or the short wavelength side. Therefore, this is characterized in that structure of a control circuit is simple.

By the way, in this example, although light signal intensity is compared using the subtraction circuit 115, a division circuit may also be used for the comparison. Additionally, in consideration of a loss of an optical filter and an optical demultiplexer, difference in conversion efficiency of a photodetector, and the like, making a comparison after assigning weights to intensity of the photodetectors 114-1, 114-2 enables improvement in control accuracy.

Moreover, in the case of this example in particular, the narrow band-pass optical filters 113-1, 113-2 can also be used as a reference device of optical frequency. In this case, it is effective if an optical filter, wavelength stability of which is increased by compensating temperature of both narrow band-pass optical filters or by other means, s used, or if a narrow band-pass optical filter itself is stabilized with reference to another optical wavelength-standard device. In addition, if the optical wavelength-standard device and the narrow band-pass optical filters are produced on the same substrate, or if they are placed inside a module that is thermally coupled, wavelength deviation of both is not caused, which enables more accurate stabilization of wavelengths.

In addition, it is significantly effective for increasing general versatility if central frequencies of the narrow band-pass optical filters 113-1, 113-2 are shifted from a reference optical wavelength beforehand so that center wavelength λ9 of a VSB signal to be output just agrees with the reference optical wavelength of a wavelength-multiplexed signal, which was defined by international standard organizations such as ITU.

In this connection, although this example shows that wavelengths are changed according to temperature using a semiconductor light source as a light source, other methods may also be used as long as it is a method in which wavelengths of light signals are changed. If it is a method in which a wavelength of a general light source is controlled from outside, the method can be applied. For example, such a method includes the following: a method in which driving electric current of a semiconductor laser is changed; a method in which a length of a resonator for a solid-state laser and for a fiber laser is changed; and the like.

In addition, this example shows that a wavelength of a light source is changed. However, a wavelength of a narrow band-pass optical filter itself may be changed to agree with a wavelength of a light signal. Transmittivity of most optical filters shifts on a wavelength axis according to temperature. Therefore, it is also possible to adjust a transmission center wavelength of a narrow-band filter so as to agree with a predetermined position of a light signal by changing temperature of the narrow band-pass optical filters 113-1 and 113-2 simultaneously for example. Moreover, any technique can be applied as long as it is a technique, which changes transmittivity of an optical filter on a wavelength axis. Such a technique includes the following: heating a light signal path of an interference optical filter; adjusting a phase by applying pressure; and changing slant of a dielectric optical filter.

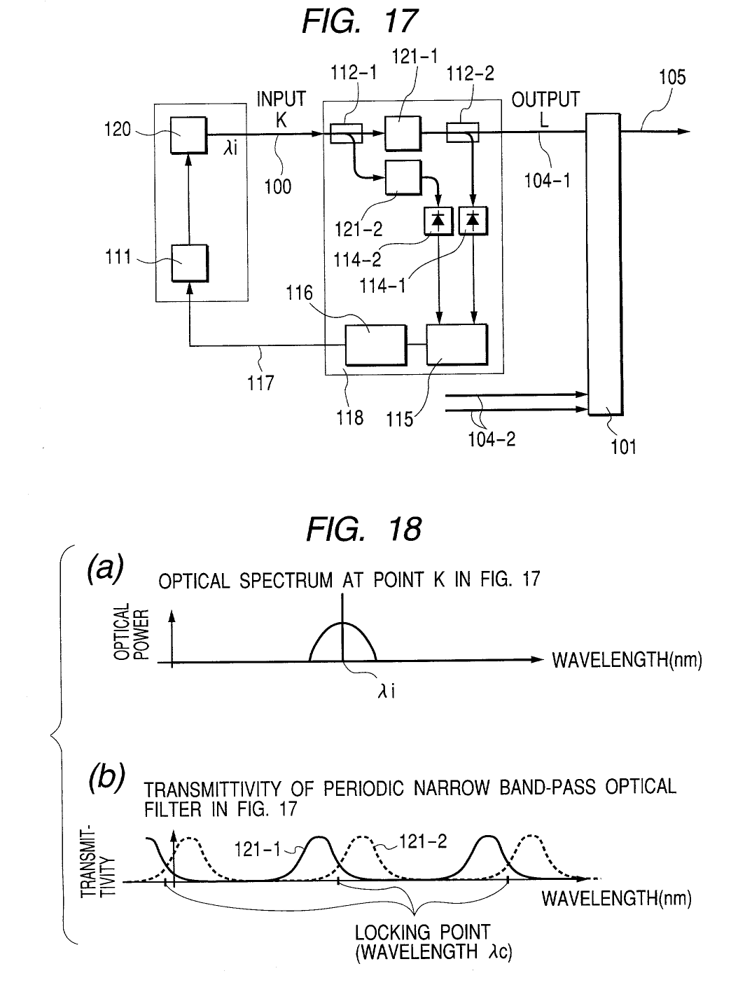

FIG. 17 illustrates a sixth embodiment of the present invention. This is an example in which a wavelength tunable laser source 120 is used as a substitute for the semiconductor light source 110, and in which a periodic optical filter 121 is used as a narrow band-pass optical filter. In this connection, in the figure, reference numeral 111 is a temperature control circuit; reference numerals 112-1, 112-2 are optical demultiplexers; reference numerals 114-1, 114-2 are photodetectors; reference numeral 115 is a subtraction circuit; reference numeral 116 is a zero-point control circuit; reference numeral 117 is a control signal; reference numeral 118 is a narrow band-pass optical filter with wavelength deviation detecting function; reference numeral 120 is a wavelength tunable laser source; and reference numerals 121-1, 121-2 are periodic narrow band-pass optical filters. In addition, reference numeral 100 is a fiber for input light; reference numerals 104-1, 104-2 are fibers for output light; and reference numeral 105 is an optical fiber. Because the periodic optical filters 121-1, 121-2 are used, a plurality of locking points, in which transmission intensity of two optical filters becomes equal, appear as shown in FIG. 18(a). As a result of it, a wavelength of a light signal can be stabilized for the plurality of wavelengths. Therefore, it becomes possible to realize a wavelength tunable VSB optical transmitter, which can output these discrete wavelengths, easily. On the other hand, if a nonperiodic narrow band-pass optical filter is used, it is necessary to shift both of a center wavelength of the narrow band-pass optical filter and a wavelength of a light signal when a wavelength is tunable. Therefore, there are the following problems: a control circuit becomes complicated, resulting in difficulty in control with a high degree of accuracy; and wavelength tunable speed becomes slow. In addition, even if the amount by which a wavelength can be tuned is large, the narrow band-pass optical filter should be moved on the wavelength axis by the same amount. Therefore, it is often difficult to realize it because of structure of the optical filter. In the present invention, the narrow band-pass optical filter has a periodic locking point. Therefore, if stability of the narrow band-pass optical filter is increased to use it also as the wavelength reference, or if the narrow band-pass optical filter is stabilized for another wavelength reference device, changing only a wavelength of a light signal suffices when the wavelength is tunable. Therefore, it is possible to simplify a method for controlling a wavelength of a light signal, and to make wavelength tunable speed higher.

By the way, this example shows a case where periods of transmittivity of two periodic optical filters are completely the same. However, even if periods of both deviate slightly, there is no problem in actuality because a locking point, where transmittivity of two filters becomes equal periodically, is obtained within a limited range of wavelength in the same manner.

Moreover, in particular, if a period of a locking point is adjusted so that the period agrees with an ITU standard wavelength or the period becomes an integral multiple, even if wavelength is made tunable, a signal wavelength always agrees with the ITU standard wavelength. Therefore, it is very advantageous. In this connection, even if the period does not agree with the ITU standard wavelength at present, higher density standard wavelength may be decided in the future. Therefore, it is also effective if the period is set at a submultiple of the ITU standard wavelength.

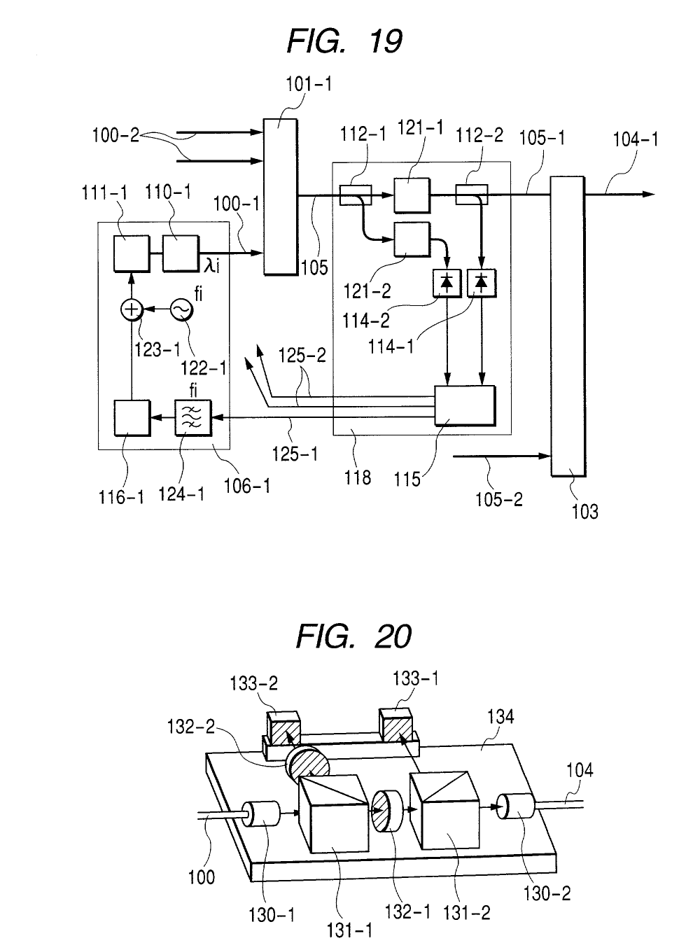

FIG. 19 illustrates a seventh embodiment of the present invention. This example applies the wavelength stabilization technique described above to the second embodiment of the present invention. For simplification, this example illustrates only a part that relates to a signal light source 106-1 having a wavelength of λi.

In the signal light source 106-1, a low frequency signal having a frequency of fi, which is obtained from a sinusoidal oscillator 122-1 beforehand, is added to a temperature control circuit 111-1 using an adder 123-1. As a result, temperature of a semiconductor light source 110-1 changes sinusoidally, causing output wavelength λi to be slightly frequency-modulated at frequency fi. The frequency fi is a specific value that is different on a signal light source basis. The frequency fi is used for identifying each wavelength. A light signal having a wavelength of λi is led to a first optical wavelength multiplexer 101-1 through an input optical fiber 100-1, where the light signal is wavelength-multiplexed with a light signal having another odd number wavelength (its wavelength is different), which is sent from another input fiber 100-2. This light signal is inputted into a narrow band-pass optical filter with wavelength control function 118, where the light signal is inputted into two periodic optical filters 121-1 and 121-2. A part of the light signal, which has been transmitted through the former, is led to a second optical wavelength multiplexer 103 through an optical fiber 105-1, and is then wavelength-multiplexed with a light signal having an even number wavelength, which is sent from an optical fiber 105-2, before the wavelength-multiplexed signal is output to an output fiber 104-1.

The periodic optical filters 121-1 and 121-2, each of which has a transmission wavelength that is slightly deviated from the other as is the case with the fifth embodiment, have a plurality of locking points as shown in FIG. 18(b). If light signals, each of which has a wavelength different from the other, are stabilized at the locking points, each of which has a wavelength different from the other, it is possible to keep a plurality of signal light wavelengths at an optimum wavelength for VSB simultaneously. In this manner, in order to stabilize a plurality of light signals simultaneously, it is necessary to separate error information for each signal light source. In this example, difference between light detection signals of two photodetectors 114-1, 114-2 is calculated by a subtraction circuit 115. A result of the calculation is distributed to each signal light source as error signals 125-1, 125-2. In the signal light source 106-1, stabilization of signal wavelengths is realized by the following processing: extracting a component of frequency fi corresponding to the signal light source 106-1 (that is to say, only an error component of this wavelength) from the error signal 125-1 using a band-pass filter 124-1; and sending the component to a zero-point control circuit 116-1. By the way, description of reference numerals in FIG. 19, which are similar to those in the figures described above, will be omitted.

In this manner, stabilizing each light signal wavelength in the periodic narrow band-pass optical filters 121-1, 121-2 according to the present invention enables omission of optical parts required for wavelength stabilization to a large extent. As a result of it, a configuration of an optical transmitter is simplified, and thereby reduction in costs becomes possible. In addition, as shown in this example, if the narrow band-pass optical filter is also used as a wavelength reference device among a plurality of light signals, it is possible to suppress accumulation of wavelength deviation caused when the plurality of devices are used. Therefore, it is possible to control a signal light wavelength more accurately in order to decrease crosstalk to adjacent wavelengths, which enables higher wavelength density of light signals.

In this example, in order to identify an error signal of each signal light source, the technique, in which a signal wavelength is modulated with a sine wave having a frequency peculiar to each wavelength, is used. However, another technique may be used as long as it has a similar function. For example, it may also be intensity modulation of light signals. In addition, a subcarrier, for which specific phase modulation, intensity modulation, frequency modulation, or the like, is performed; may be superimposed on each signal. Moreover, an identifying technique is not limited to a technique that uses a sine wave frequency. It may be correlation detection and synchronous detection using specific reference numerals, random signals, etc. In addition, for the purpose of suppressing SBS (stimulated Brillouin scattering) in an optical fiber, a component of frequency modulation, which is applied to each light source, may be used for this purpose.

FIG. 20 is a typical perspective view of an eighth embodiment of the present invention. This is a specific embodiment of the narrow band-pass optical filter with wavelength deviation detecting function 118 in the embodiment described above according to the present invention. Beam splitters and bulk optical elements are precisely implemented on a small-size temperature stabilization substrate 134 having a size of about 3×2 cm. A wavelength-multiplexed light signal, which has been inputted from an input optical fiber 100 (it corresponds to the optical fiber 105 in FIG. 19), is converted into Collimated light beam by a beam collimator 130-1 before the Collimated light beam propagates through a space. Then, the collimated light beam is divided into two light beams by a beam splitter 131-1. One light beam is inputted into a Fabry-Perot etalon 132-2 (equivalent to the periodic optical filter 121-2 in FIG. 19). After that, optical power of the light beam is converted into an electric signal by a photo diode 133-2 (equivalent to the photodetector 114-2 in FIG. 19) before the electric signal is output. The other light beam is inputted into a Fabry-Perot etalon 132-1 (equivalent to the periodic optical filter 121-1 in FIG. 19). After that, the inputted light beam is divided into two light beams again by a beam splitter 131-2. Then, optical power of one light beam is converted into an electric signal by a photo diode 133-1 (equivalent to the photodetector 114-1 in FIG. 19) before the electric signal is output. In addition, the other light beam is input into a beam collimator 130-2, and is then output from an output optical fiber 104 (it corresponds to the optical fiber 105-1 in FIG. 19). By the way, because this figure illustrates only optical parts, a subtraction circuit 115 is omitted.

In this manner, by placing a plurality of optical parts in a small-size module or substrate, it is possible to minimize influence of change in temperature and vibration, which relate to each portion. Therefore, it is effective for realization of the present invention. In addition, as shown in this example, if the Fabry-Perot etalons 132-1 and 132-2, which have large temperature dependency, are placed on the same module that is thermally coupled, it is possible to prevent wavelength deviation between both.

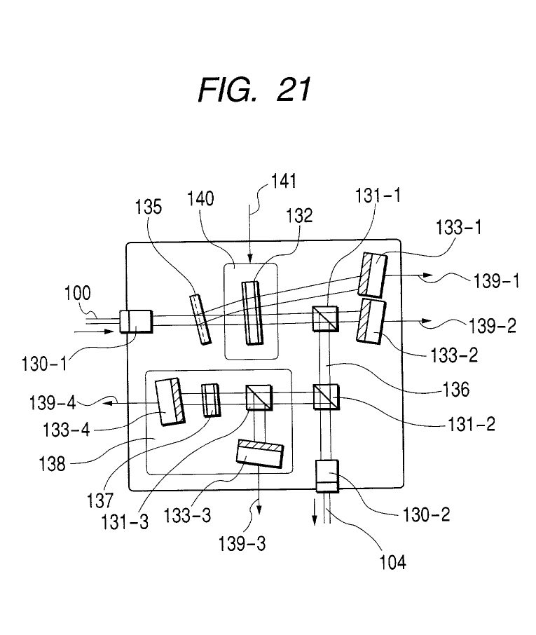

FIG. 21 is a configuration diagram illustrating a ninth embodiment of the present invention. This is also a specific embodiment of the narrow band-pass optical filter with wavelength deviation detecting function 118 according to the present invention in a similar manner. In this example, the same Fabry-Perot etalon 132 is shared as two narrow band-pass optical filters, transmission frequencies of which deviate from two light beams. In addition, a wavelength reference device is built into the Fabry-Perot etalon 132 in order to perform wavelength stabilization for wavelengths of light signals and transmission frequencies of the narrow band-pass optical filters. In the case of this example, an input light signal, which has been converted into a collimated beam by a beam collimator 130-1, is divided into two by a beam sampler 135. Both beams are inputted into the same Fabry-Perot etalon 132 with different degree of slant. Intensity of the light beams, which have been transmitted through the etalon, are detected by photodiodes 133-1, 133-2 respectively, and are then output as optical power detection signals 139-1, 139-2 respectively. As regards transmittivity of the Fabry-Perot etalon 132 for both beams, a period and a wavelength slightly deviate. Therefore, it is possible to stabilize a light signal wavelength at a point where the transmittivity becomes equal. In this manner, by sharing one optical filter for two light signals, it is possible to realize a pair of optical filters, each of which has transmission frequency that deviates from the other by fixed quantity, more simply and at lower cost. In particular, as compared with a case where two independent optical filters are used, change in characteristics for temperature change, etc. is small, which provides an advantage that it is possible to obtain extremely stable characteristics.

Also in this example, one of light signals, which have been transmitted through the Fabry-Perot etalon, is further divided by a beam splitter 131-1, and is then output as an optical VSB signal 136 from an output optical fiber 104 through a beam collimator 130-2. In this case, a part of the optical VSB signal 136 is further divided by a beam splitter 131-2, and is then led to a wavelength error detecting unit 138.

In the wavelength error detecting unit 138, the light signal is divided by a beam splitter 131-3 again. Concerning one of the divided light signals, total optical power of the light signal is measured by a photodiode 133-3. Then, a result of the measurement is output as a optical power detection signal 139-3. The other light signal is inputted in a wavelength reference device 137, where transmission signal intensity is measured by a photodiode 133-4. Then, a result of the measurement is output as a optical power detection signal 139-4. The wavelength reference device has transmittivity that changes in response to a wavelength of a light signal. In the case of the conventional wavelength stabilization technique, a wavelength of a light signal is changed to stabilize a light wavelength. However, in this example, a transmission wavelength of the Fabry-Perot etalon 132 is changed. To be more specific, temperature of a temperature control unit 140 and the Fabry-Perot etalon 132, which is implemented on this, is changed by changing a temperature control signal 141 so that a ratio of intensity between two optical power detection signals 139-3, 139-4 becomes constant. As a result, transmittivity of the Fabry-Perot etalon 132 changes slowly in a wavelength direction. Therefore, a wavelength of a light signal, which is stabilized in this Fabry-Perot etalon 132, also changes simultaneously. This permits a light signal wavelength to be stabilized so as to agree with a predetermined wavelength that is provided by the wavelength reference device 137.

In this manner, it is possible to stabilize a center wavelength of a VSB light signal so that it follows a reference wavelength prescribed by ITU by inputting a light signal after performing VSB into a wavelength stabilization device in order to achieve wavelength stabilization. Because of it, the present invention has an advantage that it is not necessary to perform complicated control in consideration of deviation in center wavelength of a light signal caused by performing VSB. In addition, because the wavelength error detecting unit 138 can be moved to outside, it is also possible to apply inexpensive standardized general-purpose parts.

As an example in which the same narrow band-pass optical filter is shared as two optical filters, each of which has transmittivity that deviates from the other, besides the example described above, it is also possible to realize it by the following means: setting it so that a phase, a reflection rate and the like, of an optical resonator change slightly due to an incident position to a narrow band-pass optical filter, an incident polarization state and the like; and inputting two light signals while changing the incident position, the polarization state and the like. Moreover, concerning a waveguide, an optical fiber grating, and the like, it is also possible to form two optical filters on the same medium. They can be utilized as the pair of optical filters described above, each of which has transmittivity and deviates from the other.

In this connection, the example described above relates to a case where a light signal having only one wavelength is inputted. However, even if a plurality of wavelengths are used, this stabilization technique can be applied. In this case, the following method may also be used: inserting an optical filter, which transmits only a specific wavelength, in an input unit of a wavelength detecting unit; and using only information on wavelength deviation for control of the Fabry-Perot etalon 132. In addition, as described in the seventh embodiment, the following method may also be used: performing low frequency sine wave modulation for each wavelength in order to enable identification of information on wavelength deviation; and performing wavelength control using this information.

As above, the embodiments of the present invention were described. Main modes are listed collectively as below.

(1) A wavelength-multiplexed narrow-bandwidth optical transmitter that is characterized by the following:

in an optical wavelength-multiplexed bandwidth narrowing method for narrowing a wavelength bandwidth of a light signal, which has been modulated by an information signal, by an optical filter, a plurality of light signals, each of which has a wavelength different from the other, are wavelength-multiplexed using the first optical wavelength multiplexer; and after that, using an optical filter having periodic transmittivity for a wavelength as the optical filter, bandwidths of the plurality of light signals are narrowed collectively.

(2) A wavelength-multiplexed vestigial-side-band optical transmitter that is characterized by the following:

in an optical vestigial-side-band modulating method that passes single side band of a light signal using an optical filter, a plurality of light signals, each of which has a wavelength different from the other, are wavelength-multiplexed using the first optical wavelength multiplexer; and using an optical filter having periodic transmittivity for a wavelength as the optical filter, only upper or lower side bands are passed from a plurality of light signals simultaneously in order to convert them into vestigial-side-band signals collectively.

(3) A wavelength-multiplexed narrow-bandwidth optical transmitter, or a wavelength-multiplexed vestigial-side-band optical transmitter, which is characterized by the following:

N (N is an integer that is greater than or equal to 2) wavelength-multiplexed narrow-bandwidth optical transmitters according to claim 1, or N wavelength-multiplexed vestigial-side-band optical transmitters according to claim 2, which output N pairs of wavelength-multiplexed signals for which wavelength interleave has been performed at Nth wavelength intervals respectively, are provided; and

said N pairs of wavelength-multiplexed light are wavelength-multiplexed by the second optical wavelength multiplexer without controlling a polarization state one another.

(4) A wavelength-multiplexed narrow-bandwidth optical transmitter, or a wavelength-multiplexed vestigial-side-band optical transmitter, which is characterized by the following:

N (N is an integer that is greater than or equal to 2) wavelength-multiplexed optical transmitters, or said N wavelength-multiplexed narrow-bandwidth optical transmitters of (1), or said N wavelength-multiplexed vestigial-side-band optical transmitters of (2), which output N pairs of wavelength-multiplexed signals for which wavelength interleave has been performed at Nth wavelength intervals respectively, are provided;

in a wavelength-multiplexed transmitter that wavelength-multiplexes said N pairs of wavelength-multiplexed light by the second optical wavelength multiplexer without controlling a polarization state one another, and that outputs the wavelength-multiplexed light, an optical wavelength multiplexer, transmittivity of which has wavelength dependency, is used as the second optical wavelength multiplexer, and in addition to it, a transmission bandwidth for each light signal having a different wavelength of the second optical wavelength multiplexer is made narrower than a spectrum width of a light signal; and

a plurality of transmission peak wavelengths of the second optical wavelength multiplexer are adjusted so as to become substantially equivalent to center wavelengths of light signals incident on the second optical wavelength multiplexer respectively, or the plurality of transmission peak wavelengths are adjusted so as to become substantially equivalent to single side band portions of the light signals respectively.

(5) A wavelength-multiplexed narrow-bandwidth optical transmitter, or a wavelength-multiplexed vestigial-side-band optical transmitter, which is characterized by the following:

N (N is an integer that is greater than or equal to 2) wavelength-multiplexed optical transmitters, or said N wavelength-multiplexed narrow-bandwidth optical transmitters of (1), or said N wavelength-multiplexed vestigial-side-band optical transmitters of (2), which wavelength-multiplex a plurality of light signals, each of which has a wavelength different from the other, using the first optical wavelength multiplexer, and which output N pairs of wavelength-multiplexed signals for which wavelength interleave has been performed at Nth wavelength intervals respectively, are provided;

in a wavelength-multiplexed transmitter that wavelength-multiplexes said N pairs of wavelength-multiplexed light using the second optical wavelength multiplexer, and that outputs the wavelength-multiplexed light,

an optical wavelength multiplexer, transmittivity of which has wavelength dependency, is used as the first optical wavelength multiplexer, and in addition to it, a transmission bandwidth for each light signal having a different wavelength of the first optical wavelength multiplexer is made narrower than a spectrum width of a light signal; and

a plurality of transmission peak wavelengths of the first optical wavelength multiplexer are adjusted so as to become equivalent to center wavelengths of light signals incident on the first optical wavelength multiplexer respectively, or the plurality of transmission peak wavelengths are adjusted so as to become substantially equivalent to single side band portions of the light signals incident on the first optical wavelength multiplexer respectively.

(6) A vestigial-side-band optical transmitter that is characterized by the following:

in a optical vestigial-side-band method that passes single side band of a light signal modulated with information signal using an optical filter,

a light signal is divided into a plurality of optical paths, and then the divided light signals are transmitted through one or more optical filters, each of which has a transmission bandwidth narrower than a spectrum width of a signal;

peak wavelengths of transmittivity of the optical filters are set so that each of the peak wavelengths slightly differs from the other for each optical path;

a light signal, which has passed through one optical path from among them, is used for transmitting an information signal as an optical vestigial-side-band signal; and

a wavelength of the light signal or a transmission wavelength of the optical filter is controlled so that intensity of the light signals, which have been transmitted through the optical paths, become equal or show a constant ratio.

(7) A wavelength-multiplexed vestigial-side-band optical transmitter that is characterized by the following:

said vestigial-side-band optical transmitter of (2), (3), (4), (5), or (6) comprises:

a first optical filter having the periodic transmittivity; and

a second optical filter that has a peak of transmittivity at a point where there is slight wavelength deviation from a peak of transmittivity of the first optical filter, and that has periodic transmittivity;

the wavelength-multiplexed light signal is divided, and the divided light signals are transmitted through the first and the second optical filters;

one wavelength-multiplexed light signal from among them, which has been transmitted through the first optical filter, is used as an optical vestigial-side-band signal; and

with respect to each light signal having a different wavelength, a wavelength of the light signal or a transmission wavelength of the optical filter is controlled so that intensity of the light signals, which have been transmitted through the first optical filter and the second optical filter, becomes equal or shows a constant ratio.

(8) A wavelength-multiplexed narrow-bandwidth optical transmitter or a vestigial-side-band optical transmitter that is characterized by the following:

in an optical wavelength-multiplexed bandwidth narrowing method for narrowing a wavelength bandwidth of a light signal, which has been modulated with an information signal, by an optical filter, or in an optical vestigial-side-band modulating method that extracts single side band of a light signal using an optical filter,

an optical filter having periodic transmittivity for a wavelength is provided as the optical filter, and a wavelength reference device having periodic characteristics for a wavelength is also provided; and

relation between a wavelength period of transmittivity of the optical filter and a wavelength period of the wavelength reference device is set at an integral multiple or a submultiple each other, or both of an integral multiple and a submultiple are used for the relation.

(9) A wavelength-multiplexed narrow-bandwidth optical transmitter or a vestigial-side-band optical transmitter that is characterized by the following:

said wavelength-multiplexed narrow-bandwidth optical transmitter or said vestigial-side-band optical transmitter of (8) comprises a tunable light source that can change an output light wavelength at least by a wavelength period of the optical filter or more.

(10) A wavelength-multiplexed narrow-bandwidth optical transmitter or a vestigial-side-band optical transmitter that is characterized by the following:

in an optical wavelength-multiplexed bandwidth narrowing method for narrowing a band of a light signal, which has been modulated with an information signal, using an optical filter, or in an optical vestigial-side-band modulating method that passes only single side band using an optical filter,

a wavelength reference device of a signal wavelength is provided; and

the optical filter and the wavelength reference device are placed on the same case or substrate so that both are thermally coupled each other, which prevents wavelength deviation in transmittivities of both.

(11) A wavelength-multiplexed narrow-bandwidth optical transmitter or a vestigial-side-band optical transmitter that is characterized by the following:

in an optical wavelength-multiplexed bandwidth narrowing method for narrowing a band of a light signal, which has been modulated with an information signal, using an optical filter, or in an optical vestigial-side-band modulating method that passes only single side band using an optical filter,

a wavelength reference device, which is used as a wavelength reference of a light signal, is provided; and

a transmission wavelength of the optical filter is controlled with reference to the wavelength reference device so that wavelength deviation in transmittivities of both from a predetermined position is not caused.

(12) A vestigial-side-band optical transmitter that is characterized by the following:

in said vestigial-side-band optical transmitter of (11),

a wavelength of a light signal is controlled so that a center wavelength of the light signal deviates from a peak of transmittivity of the optical filter by the predetermined quantity;

only single side band of the light signal is passed through the optical filter; and

a transmission wavelength of the optical filter is controlled so that a center wavelength of the light signal having only single side band agrees with the reference wavelength of the wavelength reference device.

(13) A vestigial-side-band optical transmitter that is characterized by the following:

in said (11) or (12), requirements of said (6), (7), (8), or (9) are also included as the optical filter.

### EFFECTS OF THE INVENTION

According to the present invention, it is possible to provide a higher performance optical VSB method and a higher performance optical bandwidth narrowing method. From the viewpoint of a configuration, the present invention can reduce the number of narrow band-pass optical filters, which are required when the optical VSB method or the optical bandwidth narrowing method is used, to a large extent.

In addition, according to another aspect of the present invention, using a wavelength interleave configuration enables improvement in characteristics of a periodic narrow band-pass optical filter, and also enables reduction in crosstalk, which is caused by light signals having adjacent wavelengths, at the same time.

In addition, by means of the wavelength stabilization technique according to the present invention, positional relation between a center wavelength of a light signal and a center wavelength of an optical filter can be stabilized with a high degree of accuracy, with the result that degradation in transmission characteristics and a waveform, and occurrence of crosstalk, can be prevented.

In addition, according to another aspect of the present invention, a VSB light signal and a narrow-bandwidth light signal can be obtained using a constant wavelength interval and an absolute wavelength decided by the ITU standards. Therefore, if a wavelength of a light source is made tunable, its range can be extended.

Reference numerals are as follows: 100 Input optical fiber, 101 First optical wavelength multiplexer, 102 Periodic narrow band-pass optical filter, 103 Second optical wavelength multiplexer, 104 Output optical fiber, 105 Optical fiber, 106 Signal light source, 107 Optical coupler, 108 Optical waveguide, 109 Interleaver with narrow band-pass optical filter, 110 Semiconductor light source, 111 Temperature control circuit, 112 Optical demultiplexer, 113 Narrow band-pass optical filter, 114 Photodetector, 115 Subtraction circuit, 116 Zero-point control circuit, 117 Control signal, 118 Narrow band-pass optical filter with wavelength deviation detecting function, 120 Wavelength optical filter, 122 Sinusoidal oscillator, 123 Adder, 124 Band-pass filter, 125 Error signal, 130 Beam collimator, 131 Beam splitter, 132 Fabry-Perot etalon, 133 Photodiode, 134 Temperature stabilization substrate, 135 Beam sampler, 136 Optical VSB signal, 137 Wavelength reference device, 138 Wavelength error detecting unit, 139 Optical power detection signal, 140 Temperature control unit, 141 Temperature control signal

What is claimed is:

1. A wavelength-multiplexed narrow-bandwidth optical transmitter, comprising:
a plurality of first optical transmission lines that transmit a plurality of light signals, each of which has a center wavelength different from the other;
a first optical wavelength multiplexer to which the plurality of first optical transmission lines are optically connected;
an optical filter that has predetermined periodic transmittivity for a wavelength; and
a second optical transmission line for transmitting emitted light, which is output from the optical filter;
wherein:
after the plurality of light signals, each of which has a center wavelength different from the other, are wavelength-multiplexed using the first optical wavelength multiplexer, the plurality of wavelength-multiplexed light signals are transmitted through the optical filter so that, corresponding to each of the plurality of light signals, each of which has a center wavelength different from the other, each light signal, a bandwidth of which has been narrowed as compared with each light signal before the light signal is transmitted through the optical filter, is obtained.

2. A wavelength-multiplexed vestigial-side-band optical transmitter, comprising:
a plurality of first optical transmission lines that transmit a plurality of light signals, each of which has a center wavelength different from the other;
a first optical wavelength multiplexer to which the plurality of first optical transmission lines are optically connected;
an optical filter that has predetermined periodic transmittivity for a wavelength; and
a second optical transmission line for transmitting emitted light, which is output from the optical filter;
wherein:
after the plurality of light signals, each of which has a center wavelength different from the other, are wavelength-multiplexed using the first optical wavelength multiplexer, the plurality of wavelength-multiplexed light signals are transmitted through the optical filter, and corresponding to each of the plurality of light signals, each of which has a center wavelength different from the other, only a light signal corresponding to a single side hand is transmitted from among components of each light signal before the light signal is transmitted through the optical filter, whereby each of the light signals that have been transmitted is used as a vestigial-side-band signal.

3. A wavelength-multiplexed narrow-bandwidth optical transmitter according to claim 1, comprising:
a plurality of first optical transmission lines that transmit a plurality of light signals, each of which has a enter wavelength different from the other;
a plurality of first optical wavelength multiplexers to which the plurality of first optical transmission lines are optically connected;
a plurality of optical filters, each of which is placed corresponding to each of the plurality of first optical wavelength multiplexers, each filter having predetermined periodic transmittivity for a wavelength;
a second optical wavelength multiplexer that wavelength-multiplexes a plurality of light signals, which have been transmitted through the plurality of optical filters; and
a second optical transmission line for transmitting emitted light, which is output from the second optical wavelength multiplexer;
wherein:
after the plurality of light signals, each of which has a center wavelength different from the other, are wavelength-multiplexed using the first optical wavelength multiplexer, the plurality of wavelength-multiplexed light signals are transmitted through the optical filter so that, corresponding to each of the plurality of light signals, each of which has a center wavelength different from the other, each light signal, a bandwidth of which has been narrowed as compared with each light signal before the light signal is transmitted through the optical filter, is obtained; and
a predetermined set of the first optical transmission line, the first optical wavelength multiplexer, and the optical filter outputs N pairs of wavelength-multiplexed signals, for which wavelength interleave has been performed at Nth wavelength intervals (N is an integer that is greater than or equal to 2) respectively, and said N pairs of wavelength-multiplexed light, which have been output, are wavelength-multiplexed by the second optical wavelength multiplexer without controlling a polarization state one another.

4. A wavelength-multiplexed vestigial-side-band optical transmitter according to claim 2, comprising:
a plurality of first optical transmission lines that transmit a plurality of light signals, each of which has a center wavelength different from the other;
a plurality of first optical wavelength multiplexers to which the plurality of first optical transmission lines are optically connected;
a plurality of optical filters, each of which is placed corresponding to each of the plurality of first optical wavelength multiplexers, each filter having predetermined periodic transmittivity for a wavelength;
a second optical wavelength multiplexer that wavelength-multiplexes a plurality of light signals, which have been transmitted through the plurality of optical filters; and
a second optical transmission line for transmitting emitted light, which is output from the second optical wavelength multiplexer;
wherein:
after the plurality of light signals, each of which has a center wavelength different from the other, are wavelength-multiplexed using the first optical wavelength multiplexer, the plurality of wavelength-multiplexed light signals are transmitted through the optical filter, and corresponding to each of the plurality of light signals, each of which has a center wavelength different from the other, only a light signal corresponding to a single side band is transmitted from among components of each light signal before the light signal is transmitted through the optical filter, whereby each of the light signals that have been transmitted is used as a vestigial-side-band signal; and
a predetermined set of the first optical Transmission line, the first optical wavelength multiplexer, and the optical filter outputs N pairs of wavelength-multiplexed signals, for which wavelength interleave has been performed at Nth wavelength intervals (N is an integer that is greater than or equal to 2) respectively, and said N pairs of wavelength-multiplexed light, which have been output, are wavelength-multiplexed by the second optical wavelength multiplexer without controlling a polarization state one another.

5. A wavelength-multiplexed narrow-bandwidth optical transmitter according to claim 3, wherein:
an optical wavelength multiplexer, transmittivity of which has wavelength dependency, is used as the second optical wavelength multiplexer;
in the second optical wavelength multiplexer, a transmission bandwidth for each light signal having a different wavelength is made narrower than a spectrum width of a light signal; and
a plurality of transmission peak wavelengths of the second optical wavelength multiplexer are adjusted so as to become substantially equivalent to center wavelengths of light signals incident on the second optical wavelength multiplexer respectively.

6. A wavelength-multiplexed vestigial-side-band optical transmitter according to claim 4, wherein:
an optical wavelength multiplexer, transmittivity of which has wavelength dependency, is used as the second optical wavelength multiplexer;
in the second optical wavelength multiplexer, a transmission bandwidth for each light signal having a different wavelength is made narrower than a spectrum width of a light signal; and
a plurality of transmission peak wavelengths of the second optical wavelength multiplexer are adjusted so as to become substantially equivalent to single side band portions of the light signals incident on the second optical wavelength multiplexer respectively.

7. A wavelength-multiplexed narrow-bandwidth optical transmitter according to claim 3, wherein:
an optical wavelength multiplexer, transmittivity of which has wavelength dependency, is used as the first optical wavelength multiplexer;
in the first optical wavelength multiplexer, a transmission bandwidth for each light signal having a different wavelength is made narrower than a spectrum width of a light signal; and
a plurality of transmission peak wavelengths of the first optical wavelength multiplexer are adjusted so as to become equivalent to center wavelengths of light signals incident on the first optical wavelength multiplexer respectively.

8. A wavelength-multiplexed vestigial-side-band optical transmitter according to claim 4, wherein:
an optical wavelength multiplexer, transmittivity of which has wavelength dependency, is used as the first optical wavelength multiplexer;
in the first optical wavelength multiplexer, a transmission bandwidth for each light signal having a different wavelength is made narrower than a spectrum width of a light signal; and
a plurality of transmission peak wavelengths of the first optical wavelength multiplexer are adjusted so as to become substantially equivalent to single side band portions of the light signals incident on the first optical wavelength multiplexer respectively.

9. A wavelength-multiplexed vestigial-side-band optical transmitter, comprising:
a plurality of optical transmission lines; and
at least one optical filter, which is optically connected to each of the plurality of optical transmission lines, a transmission bandwidth of said optical filter being narrower than a spectrum width of a signal that propagates through the optical transmission line;
wherein:
light signals are divided to pass the light signals through the plurality of optical transmission lines;
a peak wavelength of transmittivity of the optical filter corresponding to each of the optical transmission lines is set so that said peak wavelength is slightly different from the other peak wavelengths;
one light signal from among light signals passing through the plurality of optical transmission lines is used to transmit an information signal as an optical vestigial-side-band signal; and
a wavelength of the light signal or a transmission wavelength of the optical filter is controlled so that intensity of the light signals, each of which has been transmitted through each of the optical transmission lines, becomes equal or shows a constant ratio.

10. A wavelength-multiplexed vestigial-side-band optical transmitter according to claim 2, comprising:
a first optical demultiplexer placed in the middle of an optical path, which leads to the first optical filter via the first wavelength multiplexer;
a second optical filter on which light divided by the first optical demultiplexer falls, said second optical filter having transmittivity, a transmission bandwidth of which is narrower than a spectrum width of the light signal;
a first optical photoreceiver for receiving transmitted light from the second optical filter;
a second optical demultiplexer for dividing light, which has been transmitted through the first optical filter, into a plurality of optical paths;
a second optical photoreceiver for receiving at least one of the divided light; and
a feedback signal circuit that operates in response to signals from the first and the second optical photoreceiver;
wherein:
peak wavelengths of transmittivities of the first and second optical filters are set so that each of the peak wavelengths slightly differs from the other;
at least one of the light signals divided by the second optical demultiplexer is used to transmit an information signal as an optical vestigial-side-band signal; and
with respect to each light signal having a different wavelength, a wavelength of the light signal or a transmission wavelength of the optical filter is controlled so that intensity of light signals, which have been transmitted through the first optical filter and the second optical filter, becomes equal or shows a constant ratio.

11. A wavelength-multiplexed vestigial-side-band optical transmitter according to claim 4, comprising:
a first optical demultiplexer placed in the middle of an optical path, which leads to the first optical filter via the first wavelength multiplexer;
a second optical filter on which light divided by the first optical demultiplexer falls, said second optical filter having transmittivity, a transmission bandwidth of which is narrower than a spectrum width of the light signal;
a first optical photoreceiver for receiving transmitted light from the second optical filter;
a second optical demultiplexer for dividing light, which has been transmitted through the first optical filter, into a plurality of optical paths;
a second optical photoreceiver for receiving at least one of the divided light; and
a feedback signal circuit that operates in response to signals from the first and the second optical photoreceiver;
wherein:
peak wavelengths of transmittivities of the first and second optical filters are set so that each of the peak wavelengths slightly differs from the other;
at least one of the light signals divided by the second optical demultiplexer is used to transmit an information signal as an optical vestigial-side-band signal; and
with respect to each light signal having a different Wavelength, a wavelength of the light signal or a transmission wavelength of the optical filter is controlled so that intensity of light signals, which have been transmitted through the first optical filter and the second optical filter, becomes equal or shows a constant ratio.

12. A wavelength-multiplexed vestigial-side-band optical transmitter according to claim 6, comprising:
a first optical demultiplexer placed in the middle of an optical path, which leads to the first optical filter via the first wavelength multiplexer;
a second optical filter on which light divided by the first optical demultiplexer falls, said second optical filter having transmittivity, a transmission bandwidth of which is narrower than a spectrum width of the light signal;
a first optical photoreceiver for receiving transmitted light from the second optical filter;
a second optical demultiplexer for dividing light, which has been transmitted through the first optical filter, into a plurality of optical paths;
a second optical photoreceiver for receiving at least one of the divided light; and
a feedback signal circuit that operates in response to signals from the first and the second optical photoreceivers;
wherein:
peak wavelengths of transmittivities of the first and second optical filters are set so that each of the peak wavelengths slightly differs from the other;
at least one of the light signals divided by the second optical demultiplexer is used to transmit an information signal as an optical vestigial-side-band signal; and
with respect to each light signal having a different wavelength, a wavelength of the light signal or a transmission wavelength of the optical filter is controlled so that intensity of light signals, which have been transmitted through the first optical filter and the second optical filter, becomes equal or shows a constant ratio.

13. A wavelength-multiplexed vestigial-side-band optical transmitter according to claim 8, comprising:
a first optical demultiplexer placed in the middle of an optical path, which leads to the first optical filter via the first wavelength multiplexer;
a second optical filter on which light divided by the first optical demultiplexer falls, said second optical filter having transmittivity, a transmission bandwidth of which is narrower than a spectrum width of the light signal;
a first optical photoreceiver for receiving transmitted light from the second optical filter;
a second optical demultiplexer for dividing light, which has been transmitted through the first optical filter, into a plurality of optical paths;
a second optical photoreceiver for receiving at least one of the divided light; and
a feedback signal circuit that operates in response to signals from the first and the second optical photoreceivers;
wherein:
peak wavelengths of transmittivities of the first and second optical filters are set so that each of the peak wavelengths slightly differs from the other;
at least one of the light signals divided by the second optical demultiplexer is used to transmit an information signal as an optical vestigial-side-band signal; and
with respect to each light signal having a different wavelength, a wavelength of the light signal or a transmission wavelength of the optical filter is controlled so that intensity of light signals, which have been transmitted through the first optical filter and the second optical filter, becomes equal or shows a constant ratio.

14. A wavelength-multiplexed narrow-bandwidth optical transmitter according to claim 1, wherein:
for an optical path passing through the first wavelength multiplexer and the optical filter, the first wavelength multiplexer serves as a first optical demultiplexer that can also be used for optical division;
a wavelength reference device, on which light divided by the first optical demultiplexer falls, is additionally provided, said wavelength reference device having periodic characteristics for a wavelength; and
relation between a wavelength period of transmittivity of the optical filter and a wavelength period of the wavelength reference device is set at an integral multiple or a submultiple each other, or both of an integral multiple and a submultiple are used for the relation.

15. A wavelength-multiplexed vestigial-side-band optical transmitter according to claim 2, wherein:
for an optical path passing through the first wavelength multiplexer and the optical filter, the first wavelength multiplexer serves as a first optical demultiplexer that can also be used for optical division;
a wavelength reference device, on which light divided by the first optical demultiplexer falls, is additionally provided, said wavelength reference device having periodic characteristics for a wavelength; and
relation between a wavelength period of transmittivity of the optical filter and a wavelength period of the wavelength reference device is set at an integral multiple or a submultiple each other, or both of an integral multiple and a submultiple are used for the relation.

16. A wavelength-multiplexed narrow-bandwidth optical transmitter according to claim 14, further comprising:
a tunable light source, which can change an output light wavelength at least by a wavelength period of the optical filter or more.

17. A wavelength-multiplexed vestigial-side-band optical transmitter according to claim 15, further comprising:
a tunable light source, which can change an output light wavelength at least by a wavelength period of the optical filter or more.
